(19) United States
(12) Patent Application Publication
(10) Pub. No.: US 2025/0227598 A1
(43) Pub. Date: Jul. 10, 2025

(54) METHOD FOR OBTAINING ANALYTICS, AND COMMUNICATION DEVICE

(71) Applicant: VIVO MOBILE COMMUNICATION CO., LTD., Dongguan (CN)

(72) Inventor: Huazhang LV, Dongguan (CN)

(73) Assignee: VIVO MOBILE COMMUNICATION CO., LTD., Dongguan (CN)

(21) Appl. No.: 19/093,218

(22) Filed: Mar. 27, 2025

Related U.S. Application Data
(63) Continuation of application No. PCT/CN2023/121493, filed on Sep. 26, 2023.

(30) Foreign Application Priority Data
Sep. 29, 2022 (CN) 202211203315.7

(51) Int. Cl. H04W 40/22; H04L 41/14; H04W 48/18

(52) U.S. Cl. CPC H04W 40/22; H04L 41/14; H04W 48/18

(57) ABSTRACT

A method for obtaining an analytics, and a communication device, are provided. The method for obtaining an analytics comprises: sending a first request, wherein the first request comprises at least one piece of information, the at least one piece of information comprises at least one Route Selection Component (RSC) or at least one Protocol Data Unit (PDU) session parameter, and the first request is used for requesting to obtain an analytics; and the first communication device receives a first response, the first response comprising the analytics, wherein the analytics comprises at least one of the following: an analytics corresponding to each piece of information among the at least one piece of information; and a corresponding analytics once all information among the at least one piece of information is combined.

### CROSS-REFERENCE TO RELATED APPLICATIONS

The present application is a continuation of International Application No. PCT/CN2023/121493, filed on Sep. 26, 2023, which claims priority to Chinese Patent Application No. 202211203315.7, filed Sep. 29, 2022. The entire contents of each of the above-referenced applications are expressly incorporated herein by reference.

### TECHNICAL FIELD

The present application belongs to the technical field of communications, and specifically, relates to a method for obtaining an analytics, and a communication device.

### BACKGROUND

When an application in a terminal (also referred to as User Equipment (UE)) accesses an application server, a traffic feature of the application may be sent to the terminal. The terminal matches a user equipment route selection policy (UE Route Selection Policy (URSP)) rule according to the traffic feature, selects an appropriate Protocol Data Unit (PDU) session according to a matching result, and sends traffic of the application to the application server by using the PDU session.

Currently, in some scenarios, different URSP rules correspond to PDU sessions carrying application traffic, and performance that can be met or implemented by the PDU sessions for accessing an application server, for example, an uplink/downlink rate that can be ensured in the session or performance of a slice in which the session is located, is different. A network side considers sending or configuring an optimal URSP rule for traffic of an application, and the rule can associate or match the traffic of the application to a PDU session that can achieve optimal performance or optimal service experience. To achieve this objective, the network side needs to generate an intelligent URSP rule according to a particular analysis result. However, currently, there is still a lack of an effective technical solution to achieve such an objective. At the same time, there is still a lack of an effective technical solution for obtaining a performance analytics corresponding to a combination of a plurality of PDU session parameters at the same time at present.

### SUMMARY

Embodiments of the present application provide a method for obtaining an analytics, and a communication device.

In a first aspect, a method for obtaining an analytics is provided, including:
sending, by a first communication device, a first request, where the first request includes at least one piece of information, the at least one piece of information includes at least one route selection component (RSC) and/or at least one protocol data unit (PDU) session parameter, and the first request is used for requesting to obtain an analytics; and
receiving, by the first communication device, a first response, where the first response includes the analytics;
where the analytics includes at least one of the following:
an analytics corresponding to each piece of information among the at least one piece of information; or
a corresponding analytics once all information among the at least one piece of information is combined.

In a second aspect, an apparatus for obtaining an analytics is provided, including:
a sending module, configured to send a first request, where the first request includes at least one piece of information, the at least one piece of information includes at least one route selection component (RSC) and/or at least one protocol data unit (PDU) session parameter, and the first request is used for requesting to obtain an analytics; and
a receiving module, configured to receive a first response, the first response including the analytics;
where the analytics includes at least one of the following:
an analytics corresponding to each piece of information among the at least one piece of information; or
a corresponding analytics once all information among the at least one piece of information is combined.

In a third aspect, a method for obtaining an analytics is provided, including:
receiving, by a second communication device, a first request, where the first request includes at least one piece of information, the at least one piece of information includes at least one RSC and/or at least one PDU session parameter, and the first request is used for requesting to obtain an analytics;
determining, by the second communication device, the analytics according to the first request; and
sending, by the second communication device, a first response, where the first response includes the analytics;
where the analytics includes at least one of the following:
an analytics corresponding to each piece of information among the at least one piece of information; or
a corresponding analytics once all information among the at least one piece of information is combined.

In a fourth aspect, an apparatus for obtaining an analytics is provided, including:
a receiving module, configured to receive a first request, where the first request includes at least one piece of information, the at least one piece of information includes at least one RSC and/or at least one PDU session parameter, and the first request is used for requesting to obtain an analytics;
a determining module, configured to determine the analytics according to the first request; and
a sending module, configured to send a first response, where the first response includes the analytics;
where the analytics includes at least one of the following:
an analytics corresponding to each piece of information among the at least one piece of information; or
a corresponding analytics once all information among the at least one piece of information is combined.

In a fifth aspect, a communication device is provided, including a processor and a memory, the memory storing a program or an instruction that may run on the processor, and the program or the instruction, when executed by the processor, implements steps of the method according to the first aspect, or steps of the method according to the third aspect.

In a sixth aspect, a communication device is provided, including a processor and a communication interface, where the communication interface is configured to send a first request, the first request includes at least one piece of information, the at least one piece of information includes at least one RSC and/or at least one PDU session parameter, and the first request is used for requesting to obtain an analytics; and receive a first response, where the first response includes the analytics; where the analytics includes at least one of the following: an analytics corresponding to each piece of information among the at least one piece of information; or a corresponding analytics once all information among the at least one piece of information is combined; in some implementations, the communication interface is configured to receive a first request, where the first request includes at least one piece of information, the at least one piece of information includes at least one RSC and/or at least one PDU session parameter, and the first request is used for requesting to obtain an analytics; and the processor is configured to determine the analytics according to the first request, and the communication interface is configured to send a first response, where the first response includes the analytics; where the analytics includes at least one of the following: an analytics corresponding to each piece of information among the at least one piece of information; or a corresponding analytics once all information among the at least one piece of information is combined.

In a seventh aspect, a system for obtaining an analytics is provided, including: a first communication device and a second communication device, where the first communication device may be configured to perform steps of the method for obtaining the analytics according to the first aspect, and the second communication device may be configured to perform steps of the method for obtaining the analytics according to the third aspect.

In an eighth aspect, a readable storage medium is provided, the readable storage medium storing a program or an instruction, and the program or instruction, when executed by a processor, implementing steps of the method in the first aspect or steps of the method in the third aspect.

In a ninth aspect, a chip is provided, including a processor and a communication interface, where the communication interface is coupled to the processor, and the processor is configured to run a program or an instruction, so as to implement the method in the first aspect or the method in the third aspect.

In a tenth aspect, a computer program/program product is provided, the computer program/program product is stored in a storage medium, and the computer program/program product is executed by at least one processor to implement steps of the method for obtaining the analytics in the first aspect or steps of the method for obtaining the analytics in the third aspect.

In the embodiments of the present application, when intending to obtain the analytics, the first communication device may send a first request including at least one piece of information, where the at least one piece of information includes at least one Route Selection Component (RSC) and/or at least one PDU session parameter, and may obtain, based on the at least one piece of information, an analytics corresponding to each RSC/PDU session parameter, and/or, an analytics corresponding to a combination of a plurality of RSCs/PDU session parameters. In this way, the corresponding analytics may be obtained through one or a combination of more of RSCs/PDU session parameters, so the certain limitations may be canceled, so that obtaining of the analytics is more flexible and the requirement for obtaining the analytics is met.

### BRIEF DESCRIPTION OF THE DRAWINGS

FIG. 1 is a schematic diagram of a wireless communication system according to an embodiment of the present application;

FIG. 2 is a flowchart of a method for obtaining an analytics according to an embodiment of the present application;

FIG. 3 is a flowchart of a method for obtaining an application ID according to an embodiment of the present application;

FIG. 4 is a flowchart of a method for obtaining an analytics according to an embodiment of the present application;

FIG. 5 is a block diagram of an apparatus for obtaining an analytics according to an embodiment of the present application;

FIG. 6 is a block diagram of an apparatus for obtaining an analytics according to an embodiment of the present application;

FIG. 7 is block diagram of a communication device according to an embodiment of the present application;

FIG. 8 is a block diagram of a communication device according to an embodiment of the present application; and

FIG. 9 is a block diagram of a communication device according to an embodiment of the present application.

### DETAILED DESCRIPTION

Currently, when obtaining analysis result (analytics), a Policy Control Function (PCF) may obtain a particular PDU session parameter from a Network Data Analytics Function (NWDAF), for example, a Data Network Name (DNN), a PDU session type, and an analytics in a Session and Service Continuity Mode (SSC Mode). A process of obtaining the analytics is that the PCF can only request an analytics of one PDU session parameter each time, but cannot simultaneously request an analytics after a combination of a plurality of PDU session parameters. For example, the PCF simultaneously requests an analytics under a Data Network Name (DNN) plus a PDU session type. In addition, when obtaining these analytics, the PCF needs to provide an application ID to indicate which application it is. However, in the related art, the PCF usually can only obtain a Traffic Descriptor from a URSP rule, and there is no application ID in the traffic descriptor, resulting in that the PCF cannot obtain an analytics of an application.

To solve the foregoing technical problem, embodiments of the present application provide a method for obtaining an analytics, and a communication device. When intending to obtain an analytics, a first communication device may send a first request including at least one piece of information, where the at least one piece of information includes at least one RSC and/or at least one PDU session parameter, so that an analytics corresponding to cach RSC/PDU session parameter, and/or, a corresponding analytics once a plurality of RSCs/PDU session parameters are combined can be obtained, and a network side can also know the analytics when one PDU session includes a plurality of session parameters. According to the analytics once such the plurality of RSCs are combined, the PCF can adjust the URSP rule and modify a priority of an RSD. In addition, the application ID does not need to be provided in the first request. Therefore, certain limitations can be canceled, so that obtaining of the analytics is more flexible, and a demand for obtaining the analytics is met.

In addition, an embodiment of the present application further provides a method for obtaining an application ID. In this way, when an analytics of an application is obtained, an analytics obtaining request, when sent, may carry the application ID, and a corresponding analytics is obtained according to the application ID. Further, the embodiments of the present application further provide a method for obtaining an analytics based on a combination of an application ID and one or more RSCs, and a method for obtaining an analytics based on a combination of a traffic descriptor and one or more RSCs, so that obtaining of the analytics is more flexible.

Technical solutions in the embodiments of the present application are clearly described in the following with reference to accompanying drawings in the embodiments of the present application. Apparently, the described embodiments are merely some rather than all the embodiments of the present application. Based on the embodiments of the present application, all other embodiments obtained by those of ordinary skill in the art should fall within the scope of protection the present application.

In the specification and claims of the present application, terms such as “first” and “second” are intended to distinguish similar objects but are not used for describing a specific order or a precedence order. It should be understood that terms used in this way can be interchanged under appropriate circumstances, such that the embodiments of the present application can be implemented in a sequence other than those illustrated or described herein. In addition, the objects distinguished by “first” or “second” are usually of one type with the number of objects unlimited, for example, there may be one or more first objects. In addition, “and/or” in the specification and the claims represents at least one of connected objects, and a character “/” generally represents an “or” relationship between associated objects before and after the character.

It is worth pointing out that the technology described in the embodiments of the present application is not limited to a Long Term Evolution (LTE)/LTE-Advanced (LTE-A) system, and can also be used in other wireless communication systems, such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA) and other systems. The terms “system” and “network” in the embodiments of the present application are often used interchangeably, and the described technology can be applied to the systems and radio technologies mentioned above, and can also be applied to other systems and radio technologies. The following description describes a New Radio (NR) system for illustration, and NR terminology is used in most of the following descriptions, but these technologies can also be applied to applications other than NR system applications, such as a 6^{th} Generation (6G) communication system.

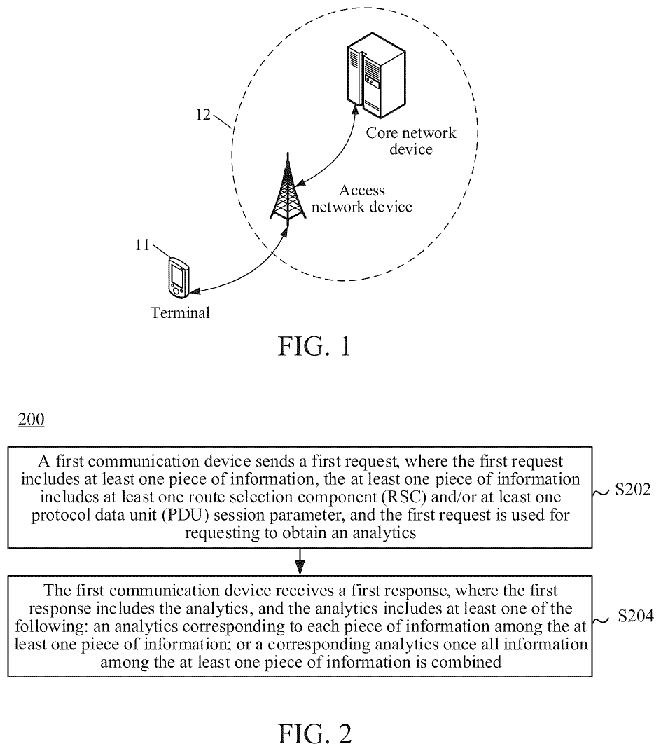

FIG. 1 shows a block diagram of a wireless communication system to which an embodiment of the present application may be applied. The wireless communication system includes a terminal 11 and a network side device 12. The terminal 11 may be a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home appliance (home equipment with a wireless communication function, such as a refrigerator, a TV, a washing machine or furniture), and terminal side equipment such as a game console, a personal computer, an ATM or a self-service machine. The wearable device includes: a smartwatch, a smart band, a smart headset, smart glasses, smart jewelry (a smart bracelet, a smart chain bracelet, a smart ring, a smart necklace, a smart anklet, a smart ankle chain, or the like), a smart wrist strap, a smart garment, or the like. It needs to be noted that a specific type of the terminal 11 is not limited in the embodiments of the present application. The network side device 12 may include an access network device or a core network device, where the access network device 12 may also be referred to as a radio access network device, a Radio Access Network (RAN), a radio access network function, or a radio access network unit. The access network device 12 may include a base station, a Wireless Local Area Network (WLAN) access point or a WiFi node, or the like. The base station may be referred to as a Node B, an evolved Node B (eNB), an access point, a Base Transceiver Station (BTS), a radio base station, a radio transceiver, a Basic Service Set (BSS), an Extended Service Set (ESS), a home Node B, a home evolved Node B, a Transmitting Receiving Point (TRP) or another appropriate term in the field. As long as the same technical effect is achieved, the base station is not limited to a specific technical word. It needs to be noted that in the embodiments of the present application, only a base station in an NR system is taken as an example for introduction, and a specific type of the base station is not limited. The core network device may include, but is not limited to, at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), an Application Function (AF), a Network Data Analytics Function (NWDAF) or the like. It needs to be noted that in the embodiments of the present application, only the core network device in the NR system is taken as an example for introduction, and a specific type of the core network device is not limited.

In the present embodiments, a first communication device, a second communication device, a third communication device, a fourth communication device, and a fifth communication device may be any one or more of the foregoing core network devices.

In the present embodiments, the first communication device may be a PCF, an Access and Mobility Management PCF (AM-PCF), a UE-PCF, or at least one core network device.

In the present embodiments, the RSC or various information or parameters (such as a PDU session type and an SSC mode) included in the RSC may also be referred to as or replaced with a PDU session parameter, a URSP rule parameter, a session-related parameter in the RSD, a PDU session attribute, a PDU session composition parameter, or the like.

A method for obtaining an analytics, and a communication device provided by the embodiments of the present application will be described below in detail through some embodiments and their application scenarios in conjunction with the accompanying drawings.

As shown in FIG. 2, an embodiment of the present application provides a method 200 for obtaining an analytics. The method may be performed by a first communication device. In other words, the method for obtaining the analytics may be performed by software or hardware installed in the first communication device. The method for obtaining the analytics includes the following steps.

S202: a first request is sent by the first communication device, where the first request includes at least one piece of information, the at least one piece of information includes at least one Route Selection Component (RSC) and/or at least one Protocol Data Unit (PDU) session parameter, and the first request is used for requesting to obtain an analytics.

When intending to obtain the analytics, the first communication device may send the first request for requesting to obtain the analytics. The first communication device may be a Policy Control Function (PCF), an Access and Mobility Management PCF (AM-PCF), or a Session Management PCF (SM-PCF).

In some implementations, the first communication device sending the first request may be that the first communication device sends the first request to a second communication device, and the second communication device may be a Network Data Analytics Function (NWDAF).

In an implementation, the first request may be at least one of the following:
Nnwdaf_AnalyticsSubscription_Subscribe (analytics subscription); or
Nnwdaf_AnalyticsInfo_Request (analytics information request).

The first request includes at least one piece of information, and the at least one piece of information includes at least one Route Selection Component (RSC) parameter and/or at least one Protocol Data Unit (PDU) session parameter. That is, the first request includes at least one RSC and/or at least one PDU session parameter. The at least one RSC or the at least one PDU session parameter may be specifically at least one of the following:
a PDU session type;
a Session and Service Continuity Mode (SSC Mode);
an access type;
Single Network Slice Selection Assistance Information (S-NSSAI); or
a Data Network Name (DNN).

The PDU session type may include at least one of the following:
an Ethernet type;
unstructured;
an Internet protocol fourth version (IPV4) type;
an Internet protocol sixth version (IPV6) type; or
an IPV4V6 type.

The SSC mode includes at least one of the following:
SSC mode 1;
SSC mode 2; or
SSC mode 3.

The access type includes at least one of the following:
Wireless Local Area Networks (WLAN); in some implementations, in a case that the access type is the WLAN, the first request may further include at least one of a Service Set IDentifier (SSID), a Basic Service Set IDentifier (BSSID), or a Homogenous Extended Service Set IDentifier (HESSID);
a Public Land Mobile Network (PLMN) ID;
a 5th Generation Mobile Communication Technology (5G);
a 4th Generation Mobile Communication Technology (4G);
a Next Generation (NG) Radio Access Network (NG-RAN);
an Evolved Universal Mobile Telecommunications System Terrestrial Radio Access Network (E-UTRAN);
trusted WLAN (TRUSTED_WLAN); or
multi-access.

In the embodiment of the present application, in a case that the first request includes at least one piece of information, the analytics that the first request is used for requesting to obtain may include at least one of the following:
an analytics corresponding to each piece of information among the at least one piece of information; or
a corresponding analytics once all information among the at least one piece of information is combined.

Each piece of information among the at least one piece of information is each RSC in the foregoing at least one RSC and/or each PDU session parameter in the at least one PDU session parameter, and all information among the at least one piece of information is all RSCs in the foregoing at least one RSC and/or all PDU session parameters in the at least one PDU session parameter.

In some implementations, the analytics corresponding to each piece of information among the at least one piece of information may include at least one of the following:
an analytics corresponding to each RSC in the at least one RSC; or
an analytics corresponding to each PDU session parameter in the at least one PDU session parameter.

The corresponding analytics once all information in the at least one piece of information is combined may include at least one of the following:
a corresponding analytics once all RSCs in the at least one RSC are combined; or
a corresponding analytics once all PDU session parameters in the at least one PDU session parameter are combined.

For convenience of description, an example in which the at least one piece of information included in the first request is at least one RSC may be used for description below. The at least one RSC included in the first request in the following embodiments may be replaced with the at least one PDU session parameter included in the first request, or replaced with the at least one PDU session parameter and the at least one RSC included in the first request.

In a case that the first request includes at least one RSC, the first request may be used for requesting to obtain an analytics corresponding to each RSC in the at least one RSC. For example, when the first request includes both the DNN and the S-NSSAI, for example, DNN-1 and S-NSSAI-a, the first request may be used for requesting an analytics corresponding to DNN-1 and/or an analytics corresponding to S-NSSAI-a. In this case, the first request is used for requesting the analytics corresponding to each individual RSC in the at least one RSC. A communication device, for example, the second communication device, receiving the first request respectively provides an analytics corresponding to each RSC, for example, an analytics corresponding to DNN-1 (for example, an uplink and downlink rate, a packet loss rate or the like that can be achieved when the DNN-1 is accessed) and an analytics corresponding to S-NSSAI-a (for example, an uplink and downlink rate, a packet loss rate or the like that can be achieved when a slice is used to access an application server).

In a case that the first request includes at least one RSC, the first request may be used for requesting to obtain a corresponding analytics once various RSCs in the at least one RSC are combined. For example, when the first request includes both the DNN and the S-NSSAI, for example, DNN-1 and S-NSSAI-a, the first request may be used for requesting an analytics corresponding to DNN-1+S-NSSAI-a, that is, requesting to obtain performance that can be achieved by accessing DNN-1 through an S-NSSAI-a slice. In this case, the first request is used for requesting an analytics once individual RSCs in the at least one RSC are combined. The communication device, for example, the second communication device, receiving the first request respectively provides the corresponding analytics once the various RSCs are combined, for example, the analytics corresponding to DNN-1+S-NSSAI-a (for example, an uplink and downlink rate, a packet loss rate or the like that can be achieved when it is connected into DNN-1 at the same time by using the slice S-NSSAI-a and then the application server is accessed by using the two parameters).

In some implementations, in a case that the first request includes one RSC, the first request is used for requesting to obtain an analytics corresponding to the RSC. In a case that the first request includes a plurality of RSCs, the first request is used for requesting to obtain an analytics corresponding respectively to each RSC in the plurality of RSCs, and/or, a corresponding analytics once the plurality of RSCs are combined (that is, an analytics corresponding to a combination of the plurality of RSCs).

For example:
in a case that the first request includes the PDU session type (for example, the PDU session type is an Internet Protocol (IP) type), the first request is used for requesting to obtain an analytics when the PDU session type is the IP type, and the analytics represents performance achieved by all terminals or any terminal after using the IP type of the PDU session. In this case, traffic of which application is carried by the PDU session of the IP type is of no interest, and the analytics represents traffic of any application.

In a case that the first request includes an SSC mode (for example, the SSC mode is SSC mode 3), the first request is used for requesting to obtain an analytics when a PDU session is the SSC mode 3. The analytics reflects performance of all terminals or any terminal when the PDU session is the SSC mode 3, and traffic of which application is carried in the PDU session in the SSC mode 3 is of no interest.

In a case that the first request includes the access type (for example, the access type is a cellular access or a 3rd Generation Partnership Project (3GPP) access), the first request is used for requesting to obtain an analytics when the access type of the PDU session is a 3GPP access.

In a case that the first request includes the S-NSSAI (for example, the slice is S-NSSAI-a), the first request is used for requesting to obtain an analytics of the slice S-NSSAI-a. The analytics of the slice S-NSSAI-a refers to performance that the session can provide or experience that the session can make the application obtain, for example, an uplink and downlink rate or a packet loss rate, when application traffic is transmitted in the PDU session and a session parameter of the PDU session includes the S-NSSAI-a or the PDU session is established in a slice corresponding to the S-NSSAI-a.

In a case that the first request includes the DNN, the first request is used for requesting to obtain the analytics of accessing the application server through the DNN.

For another example:
in a case that the first request includes the PDU session type (for example, the PDU session type is an IP type) and the SSC mode (for example, SSC mode 3), the first request may be used for requesting to obtain an analytics when the PDU session type is the IP type and an analytics when the PDU session is the SSC mode 3, and/or, used for requesting to obtain one analytics. The analytics is a performance analytics when the PDU session satisfies both: the type of the PDU session is the IP type, and the SSC mode is SSC mode 3; that is, the first request may further request to obtain application experience or performance that can be achieved by using a PDU session to carry the application traffic when such PDU session is the IP type and meanwhile the SSC mode is 3.

In a case that the first request includes the PDU session type (for example, the IP type), the SSC mode (for example, SSC mode 3), and the access type (for example, the 3GPP access), the first request may be used for requesting to obtain an analytics when the PDU session type is the IP type, an analytics when the PDU session is the SSC mode 3, and an analytics when the access type is the 3GPP access, and/or, used for requesting to obtain an analytics after one RSC combination. That is, the first request may further request to obtain application experience or performance that can be achieved by using one PDU session having such PDU session parameters to carry application traffic when the PDU session is the IP type, the SSC mode is 3 and meanwhile, the access type is the 3GPP access.

Certainly, in a case that the first request includes other RSCs, the first request may be used for requesting to obtain an analytics corresponding to each RSC, and/or, used for requesting to obtain an analytics corresponding to a combination of all RSCs. Examples are not provided herein one by one.

In some implementations, in a case that the first request includes at least one piece of information, the first request may further include second information, and the second information is used for indicating at least one of the following:
obtaining the analytics corresponding to cach piece of information among the at least one piece of information; or
obtaining the corresponding analytics once all information among the at least one piece of information is combined.

That is, an example in which the at least one piece of information is at least one RSC is used. While sending the first request (including the at least one RSC), the first communication device may further send the second information, to indicate, by using the second information, which analytics the first request specifically requests to obtain.

The second information may further indicate whether the second communication device, for example, the NWDAF, should provide an analytics corresponding to cach individual RSC in the at least one RSC or an analytics once all RSCs are combined.

For example, in a case that the first request includes the PDU session type (IP type), the SSC mode (SSC mode 3), and the second information:
if the second information is used for indicating to obtain an analytics corresponding to each RSC of the at least one RSC, the first request is specifically used for requesting to obtain an analytics when the PDU session type is an IP type and an analytics when the SSC mode of the PDU session is an SSC mode 3;
if the second information is used for indicating to obtain a corresponding analytics once all RSCs in the at least one RSC are combined, the first request is specifically used for requesting to obtain an analytics after one RSC combination. That is, the analytics indicates performance or application experience that can be achieved after one PDU session is used. The PDU session has the following parameters or features: the type of the PDU session is an IP type and an SSC mode is SSC mode 3; and
if the second information is used for indicating to obtain an analytics corresponding to each RSC in the at least one RSC and a corresponding analytics once all RSCs in the at least one RSC are combined, this case indicates that the analytics corresponding to cach RSC and the analytics once all RSCs are combined are requested at the same time, and these analytics need to be provided. That is, the first request is specifically used for requesting to obtain an analytics when the PDU session type is the IP type, an analytics when the PDU session is the SSC mode 3, and an analytics after the two parameters are combined, namely, the type of the PDU session is the IP type and the SSC mode of the PDU session is the SSC mode 3.

In the present embodiment, the analytics refers to that when the PDU session is used to carry application traffic and in the PDU session, a parameter of the session is one of the at least one RSC.

In this way, which analytics is requested to be obtained may be indicated by using the second information. Therefore, the obtained analytics may be more accurate.

The first communication device receives the analytics through the first response. The analytics may be an analytics corresponding to each RSC in the at least one RSC, or may be performance that can be achieved or implemented or a corresponding analytics once all RSCs in the at least one RSC are combined.

The first response includes at least one of the following:
Nnwdaf_AnalyticsSubscription_Notify (analytics subscription notification); or
Nnwdaf_AnalyticsInfo_Response (analytics information response).

The analytics mainly describes, when an attribute of the PDU session carrying the application traffic, such as a PDU session type, an SSC mode, a DNN, or a slice, is the same as at least one RSC in the first request or is the same as a combination of a plurality of RSCs, performance statistics or performance prediction on service experience or service access that can be achieved by using this session to carry the application traffic. The performance statistics or performance prediction is an analytics, and includes the following:
an average packet delay;
an average packet loss rate;
a throughput;
Quality of Service (QoS) flow Bit Rate, (QoS flow bit rate), uplink or downlink;
QoS flow Packet Delay (QoS flow packet delay), uplink or downlink;
Packet transmission (the quantity of packet transmission);
Packet retransmission (the quantity of packet retransmission); and
service experience on an application server side, for example, an uplink and downlink rate, a bandwidth, a packet delay, a packet loss rate, data burst conditions, and the like.

In the embodiment of the present application, when the analytics is obtained, an analytics corresponding to cach RSC and/or a corresponding analytics once all RSCs are combined may be obtained according to the at least one RSC, and an application ID does not need to be provided. Therefore, certain limitations may be canceled, so that the analytics is obtained more flexibly and more conveniently.

In some implementations, in addition to obtaining the corresponding analytics by using the at least one RSC or the at least one PDU session parameter, the at least one RSC or the at least one PDU session parameter may further be combined with other information, and the corresponding analytics after the combination is obtained, so that obtaining of the analytics is more flexible. The another information may be an application ID or a traffic descriptor parameter (Traffic descriptor). Detailed descriptions are made below.

In some implementations, in a case that the first request includes the at least one piece of information, the first request may further include an application ID (application ID) of the target application. The application ID of the target application may be obtained by the first communication device according to the traffic descriptor parameter, and it may specifically include the following steps:
a second request is sent by the first communication device, where the second request includes the traffic descriptor parameter, and the second request is used for requesting to obtain an application ID of a target application corresponding to the traffic descriptor parameter; and
a second response is received by the first communication device, where the second response includes the application ID of the target application.

In some implementations, a mapping relationship between an application ID and a traffic descriptor may be pre-established or obtained, and the mapping relationship may be stored in the at least one core network device. When intending to obtain the analytics related to the target application, the first communication device may obtain the traffic descriptor parameter in a URSP rule (rule), and then send the second request including the traffic descriptor parameter, to request an application ID of the target application that corresponds to or is equivalent to the traffic descriptor parameter. The first communication device may receive the second response after sending the second request. The second response includes the application ID of the target application corresponding to the traffic descriptor parameter.

The traffic descriptor parameter may include at least one of the following:
connection capabilities (Connection Capabilities);
application descriptors (Application descriptors);
IP descriptors (IP descriptors);
non-IP descriptors (Non-IP descriptors);
a Fully Qualified Domain Name (FQDN), namely, domain descriptors (Domain descriptors); or
DNN.

In an implementation, for example, there is the following URSP rule:

| | |
|---|---|
| Rule Precedence = 1 | Route Selection Descriptor Precedence = 1 |
| Traffic Descriptor: | Network Slice Selection: S-NSSAI-a |
| Application descriptor = App1 | SSC Mode Selection: SSC Mode 3 |
| | Access Type preference: 3GPP access. |

If the RSC included in the first request happens to be all RSCs under a particular RSD in a traffic descriptor under a particular URSP rule, for example, the first request includes: a network slice is selected as S-NSSAI-a, an SSC Mode is SSC Mode 3, an access manner is Access Type preference: 3GPP access, and the three RSC parameters just form one RSD under one traffic descriptor under one URSP rule in the foregoing table. In this case, the first request may be considered as requesting an analytics or performance corresponding to an RSD, for example, may be considered as requesting performance under RSD precedence=1 when traffic descriptor=APP1. For another example, if in this case, under the URSP rule, there is only one RSD in the traffic descriptor, the first request may further be considered as requesting to obtain performance of a traffic descriptor under a URSP rule, for example, may be considered as obtaining performance of traffic descriptor=APP1.

In some implementations, the first communication device may send the second request to a third communication device when sending the second request. The third communication device may be a Network Exposure Function (NEF). Correspondingly, when receiving the second response, the first communication device may receive the second response from the third communication device. The application ID of the target application included in the second response may be determined by the third communication device according to the traffic descriptor parameter included in the second request and a preset mapping relationship. The mapping relationship is a mapping relationship between the traffic descriptor parameter and the application ID.

In some implementations, the foregoing mapping relationship may be provided by the third communication device. That is, the third communication device may pre-establish or obtain the mapping relationship between the traffic descriptor parameter and the application ID. When intending to obtain the application ID of the target application, the first communication device may send the second request including the traffic descriptor parameter to the third communication device. After receiving the second request, the third communication device may search the pre-established mapping relationship for the corresponding application ID according to the traffic descriptor parameter included in the second request. In a case that the corresponding application ID is searched out, the third communication device sends the second response to the first communication device. The second response includes the searched-out application ID.

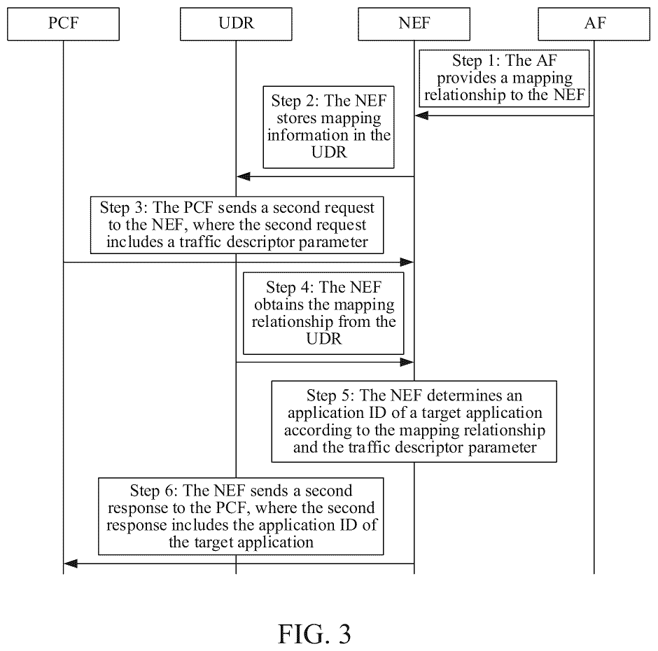

In some implementations, the foregoing mapping relationship may also be obtained from a fourth communication device by the third communication device, and the mapping relationship in the fourth communication device may be provided by a fifth communication device and stored by the fifth communication device into the fourth communication device through the third communication device. The fourth communication device may be a Unified Data Repository (UDR), and the fifth communication device may be an Application Function (AF). For a procedure of storing the mapping relationship and obtaining the application ID, refer to FIG. 3.

As shown in FIG. 3, the UDR (the fourth communication device) storing the mapping relationship and the PCF (the first communication device) obtaining the application ID may include the following steps.

Step 1: the AF provides the mapping relationship to the NEF.

The mapping relationship is a mapping relationship between at least one traffic descriptor parameter and an application ID (application ID), and the traffic descriptor parameter may include at least one of the following:
Application descriptor; including an OSId operating system ID or an OSAppId operating system APP ID;
an IP descriptor, for example, an IP address or port of one or more application servers (Application server IP address or port);
a Non-IP descriptor, for example, non-IP address information of one or more application servers, for example, a Media Access Control Address (MAC address), and an application server non-IP address (Application server non-IP address);
an FQDN descriptor, for example, FQDNs of one or more application servers (Application server FQDN); or
connection capabilities such as an IP Multimedia Subsystem (IMS) or the Internet.

Step 2: the NEF stores mapping information into the UDR.

Step 3: the PCF sends a second request to the NEF, where the second request includes the traffic descriptor parameter.

When intending to obtain the analytics corresponding to the application ID, the PCF may obtain the traffic descriptor parameter from the URSP rule, and send the second request to the NEF. The second request includes the traffic descriptor parameter, and the second request is used for requesting to obtain the application ID of the target application corresponding to the traffic descriptor parameter. If the NEF already stores the mapping relationship, the NEF may directly send a corresponding application ID to the PCF.

Step 4: the NEF obtains the mapping relationship from the UDR.

In some implementations, the UDR sends the application ID corresponding to the traffic descriptor included in the second request to the NEF.

Step 5: the NEF determines the application ID of the target application according to the mapping relationship and the traffic descriptor parameter.

In some implementations, the NEF receives the application ID corresponding to the traffic descriptor from the UDR.

Step 6: the NEF sends the second response to the PCF, where the second response includes the application ID of the target application.

After obtaining the application ID of the target application by using the foregoing method, the second communication device may send the first request based on the application ID. The first request includes the application ID and at least one RSC.

In the embodiment of the present application, in a case that the first request includes the application ID and the at least one piece of information, the analytics that the first request is used for requesting to obtain may include at least one of the following:
a corresponding analytics once the application ID is combined with each piece of information among the at least one piece of information; or
a corresponding analytics once the application ID is combined with all information among the at least one piece of information.

In some implementations, the corresponding analytics once the application ID is combined with each piece of information among the at least one piece of information may include at least one of the following:
a corresponding analytics once the application ID is combined with each RSC in the at least one RSC; or
a corresponding analytics once the application ID is combined with cach PDU session parameter in the at least one PDU session parameter.

The corresponding analytics once the application ID is combined with all information among the at least one piece of information may include at least one of the following:
a corresponding analytics once the application ID is combined with all RSCs in the at least one RSC; or
a corresponding analytics once the application ID is combined with all PDU session parameters in the at least one PDU session parameter.

In some implementations, Using an example in which the at least one piece of information is at least one RSC, in a case that the first request includes an application ID and at least one RSC, the first request is used for requesting to obtain a corresponding analytics once the application ID is combined with each RSC respectively, and/or, a corresponding analytics once the application ID is combined with the at least one RSC.

For example:
in a case that the first request includes the application ID of the target application and the PDU session type (for example, an IP type), the first request is used for requesting to obtain an analytics when the target application is carried in a PDU session and the PDU session type is the IP type.

In a case that the first request includes the application ID of the target application and the SSC mode (for example, the SSC mode 3), the first request is used for requesting to obtain an analytics when the target application is carried in a PDU session, and the PDU session is the SSC mode 3.

When the first request includes the application ID of the target application and the access type (for example, the 3GPP access), the first request is used for requesting to obtain an analytics when the target application is carried in a PDU session and the access type of the PDU session is the 3GPP access.

In a case that the first request includes the application ID of the target application and the DNN, the first request is used for requesting to obtain an analytics that the application traffic is carried through the PDU session, and the PDU session accesses the target application or a target application server through the DNN.

For another example:
in a case that the first request includes the application ID of the target application, the PDU session type (the IP type), and the SSC mode (SSC mode 3), the first request may be used for requesting to obtain an analytics when the target application is carried in a PDU session and the PDU session type is the IP type, and an analytics when the target application is carried in the PDU session and the PDU session is the SSC mode 3, and/or used for requesting to obtain a performance analytics when the target application is carried in the PDU session, the PDU session type is the IP type and the SSC mode of the PDU session is the SSC mode 3.

In a case that the first request includes the application ID of the target application, the PDU session type (the IP type), the SSC mode (SSC mode 3), and the access type (3GPP access), the first request may be used for requesting to obtain an analytics when the target application is carried under the PDU session and the PDU session type is the IP type, an analytics when the target application is carried under the PDU session and the PDU session is the SSC mode 3, and an analytics when the target application is carried under the PDU session and the access type of the session is the 3GPP, and/or used for requesting to obtain an analytics when the target application is carried under the PDU session, the type of the PDU session is the IP type, the SSC mode is the SSC mode 3, and the access type is the 3GPP access.

Certainly, in a case that the first request includes the application ID of the target application and another RSC, the first request may be used for requesting to obtain a corresponding analytics once the application ID is combined with each RSC respectively, and/or, used for requesting to obtain a corresponding analytics once the application ID is combined with all RSCs. Examples are not provided herein one by one.

In some implementations, in a case that the first request includes the application ID of the target application and at least one piece of information, the first request may further include third information, and the third information is used for indicating at least one of the following:
obtaining the corresponding analytics once the application ID is combined with cach piece of information among the at least one piece of information; or
obtaining the corresponding analytics once the application ID is combined with all information among the at least one piece of information.

That is, an example in which the at least one piece of information is at least one RSC is used. While sending the first request (including the application ID and the at least one RSC), the first communication device may further send the third information, to indicate, through the third information, which analytics the first request specifically requests to obtain.

For example, in a case that the first request includes the application ID of the target application, the PDU session type (the IP type), the SSC mode (SSC mode 3), and the third information:
if the third information is used for indicating to obtain a corresponding analytics once the application ID is combined with each RSC in the at least one RSC, the first request is specifically used for requesting to obtain an analytics when the target application is carried under the PDU session and the PDU session type is the IP type and an analytics when the PDU session is SSC mode 3 for the target application.

If the third information is used for indicating to obtain a corresponding analytics once the application ID is combined with all RSCs in the at least one RSC, the first request is specifically used for requesting to obtain an analytics when the target application is carried under the PDU session, and the PDU session simultaneously satisfies that: the type of PDU session is the IP type and the SSC mode is SSC mode 3.

If the third information is used for indicating to obtain a corresponding analytics once the application ID is combined with each RSC in the at least one RSC and a corresponding analytics once the application ID is combined with all RSCs in the at least one RSC, the first request is specifically used for requesting to obtain an analytics when the target application is carried under the PDU session and the PDU session type is the IP type, an analytics when the target application is carried under the PDU session and the PDU session is SSC mode 3, and an analytics when the target application is carried under the PDU session, and the PDU session simultaneously satisfies that: the type of the PDU session is the IP type and the SSC mode is SSC mode 3.

In this way, which analytics is requested to be obtained may be indicated by using the third information. Therefore, the obtained analytics may be more accurate.

In some implementations, in a case that the first request includes the at least one piece of information, the first request may further include the traffic descriptor parameter, and the traffic descriptor parameter may include at least one of the following:
connection capabilities (Connection Capabilities);
application descriptors (Application descriptors);
IP descriptors (IP descriptors);
non-IP descriptors (Non-IP descriptors);
a Fully Qualified Domain Name (FQDN), namely, domain descriptors (Domain descriptors); or
DNN.

In a case that the first request includes the traffic descriptor parameter and at least one piece of information, the analytics that the first request is used for requesting to obtain may include at least one of the following:
a corresponding analytics once the traffic descriptor parameter is combined with each piece of information among the at least one piece of information; or
a corresponding analytics once the traffic descriptor parameter is combined with all information among the at least one piece of information.

In some implementations, the corresponding analytics once the traffic descriptor parameter is combined with each piece of information among the at least one piece of information may include at least one of the following:
a corresponding analytics once the traffic descriptor parameter is combined with each RSC in the at least one RSC; or
the corresponding analytics once the traffic descriptor parameter is combined with each PDU session parameter in the at least one PDU session parameter.

The corresponding analytics once the traffic descriptor parameter is combined with each piece of information among the at least one piece of information may include at least one of the following:
a corresponding analytics once the traffic descriptor parameter is combined with all RSCs in the at least one RSC; or
a corresponding analytics once the traffic descriptor parameter is combined with all PDU session parameters in the at least one PDU session parameter.

In some implementations, using an example in which the at least one piece of information is at least one RSC, in a case that the first request includes the traffic descriptor parameter and the at least one RSC, the first request is used for requesting to obtain a corresponding analytics once the traffic descriptor parameter is combined with each RSC respectively, and/or a corresponding analytics once the traffic descriptor parameter is combined with the at least one RSC.

For example:
in a case that the first request includes an IP/Non-IP descriptor and the PDU session type (for example, the IP type), the first request is used for requesting to obtain an analytics when a type of a PDU session for accessing an application server corresponding to the IP/Non-IP descriptor is the IP type.

In a case that the first request includes the connection capabilities (“ims”, “multimedia messaging service (Multimedia Messaging Service, mms)”, “internet”) and also includes the application ID of the target application and the SSC mode (SSC mode 1), the first request is used for requesting an analytics when the PDU session carries an application traffic corresponding to the application ID, the PDU session supports SSC mode 1 and the PDU session is connected to a network indicated by the connection capabilities (for example, ims (IP Multimedia Subsystem), Internet, etc.).

In a case that the first request includes the DNN and the access type (non-3GPP, WLAN, SSID=AAA), the first request is used for requesting to obtain an analytics when the DNN is accessed, an access type of the PDU session that accesses the DNN is a WLAN access and WLAN SSID=AAA.

For another example, in a case that the first request includes the DNN, the PDU session type (the IP type) and the SSC mode (SSC mode 1), the first request is used for requesting to obtain the analytics when the DNN is accessed and the type of PDU session that accesses the DNN is the IP type, an analytics when the DNN is accessed and the PDU session that accesses the DNN is SSC mode 1, and/or used for requesting to obtain an analytics when the DNN is accessed and the PDU session that accesses the DNN simultaneously satisfies that the PDU session type is IP type and the SSC mode is SSC mode 1.

Certainly, in a case that the first request includes other traffic descriptor parameters and other RSCs, the first request may be used for requesting to obtain a corresponding analytics once the other traffic descriptor parameters are combined with each RSC respectively, and/or, used for requesting to obtain a corresponding analytics once the other traffic descriptor parameters are combined with all RSCs. Examples are not provided herein one by one.

In some implementations, in a case that the first request includes the traffic descriptor parameter and at least one piece of information, the first request may further include fourth information, and the fourth information is used for indicating at least one of the following:
obtaining the corresponding analytics once the traffic descriptor parameter is combined with each piece of information among the at least one piece of information; or
obtaining the corresponding analytics once the traffic descriptor parameter is combined with all information among the at least one piece of information.

That is, an example in which the at least one piece of information is at least one RSC is used, while sending the first request (including the traffic descriptor parameter and the at least one RSC), the first communication device may further send the fourth information, to indicate, through the fourth information, which analytics the first request specifically requests to obtain.

For example, in a case that the first request includes the DNN, the PDU session type (the IP type), the SSC mode (SSC mode 1) and the fourth information:
if the fourth information is used for indicating to obtain the corresponding analytics once the traffic descriptor parameter is combined with each RSC in the at least one RSC, the first request is specifically used for requesting to obtain an analytics when the DNN is accessed and the type of the PDU session that accesses the DNN is the IP type and an analytics when the DNN is accessed and the SSC mode of the PDU session that accesses the DNN is SSC mode 1;
if the fourth information is used for indicating to obtain the corresponding analytics once the traffic descriptor parameter is combined with all RSCs in the at least one RSC, the first request is specifically used for requesting to obtain an analytics when the DNN is accessed, and the PDU session that accesses the DNN simultaneously satisfies that the type of the PDU session is the IP type and the SSC mode is SSC mode 1; and
if the fourth information is used for indicating to obtain the analytics corresponding to the traffic descriptor parameter and each RSC in the at least one RSC and the corresponding analytics once the traffic descriptor parameter is combined with all RSCs in the at least one RSC, the first request is specifically used for requesting to obtain an analytics when the DNN is accessed and the type of the PDU session that accesses the DNN is the IP type, an analytics when the DNN is accessed and the SSC mode of the PDU session that accesses the DNN is SSC mode 1, and an analytics when the DNN is accessed and the PDU session that accesses the DNN simultaneously satisfies that the type of the PDU session is the IP type and the SSC mode is SSC mode 1.

In this way, which analytics is requested to be obtained may be indicated through the fourth information. Therefore, the obtained analytics may be more accurate.

S204: the first communication device receives the first response, where the first response includes the analytics.

The first communication device may receive the first response after sending the first request. The first response includes the analytics that the first request is used for requesting to obtain.

In some implementations, using an example in which the at least one piece of information in the first request is at least one RSC, in a case that the first request includes the at least one RSC, the analytics may include an analytics corresponding to each RSC in the at least one RSC, and/or, a corresponding analytics once all RSCs in the at least one RSC are combined; in a case that the first request includes the at least one RSC and the second information, the analytics may be an analytics indicated by the second information; in a case that the first request includes the application ID of the target application and at least one RSC, the analytics may include a corresponding analytics once the application ID is combined with cach RSC in the at least one RSC, and/or, a corresponding analytics once the application ID is combined with all RSCs in the at least one RSC; in a case that the first request includes the application ID of the target application, the at least one RSC, and the third information, the analytics may be an analytics indicated by the third information; in a case that the first request includes the traffic descriptor parameter and the at least one RSC, the analytics may include the corresponding analytics once the traffic descriptor parameter is combined with cach RSC in the at least one RSC, and/or, the corresponding analytics once the traffic descriptor parameter is combined with all RSCs in the at least one RSC; and in a case that the first request includes the traffic descriptor parameter, the at least one RSC, and the fourth information, the analytics may be an analytics indicated by the fourth information.

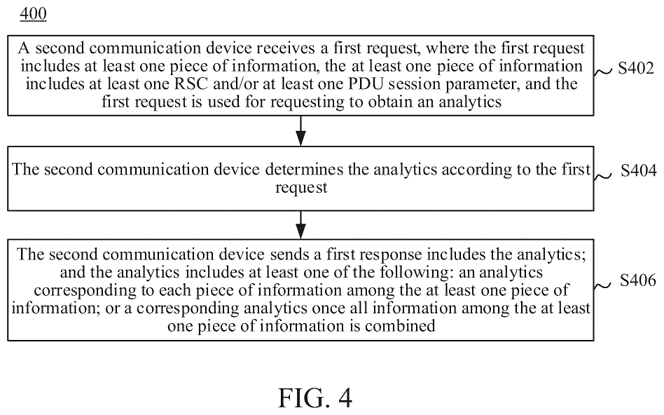

In some implementations, the first communication device receiving the first response may be that the first communication device receives the first response from the second communication device. The analytics included in the first response is determined and obtained by the second communication device according to the first request. For details, refer to the embodiment shown in FIG. 4, and details are not described herein again.

After receiving the first response, the first communication device can learn, according to the first response, corresponding performance when a certain application (server) is accessed by using the PDU session and a session parameter or attribute of the PDU session is set to some particular values or a particular configuration (for example, a session type, an SSC mode, or an access mode).

For example, if the first request includes the application ID (application ID=Tencent) of the target application and SSC mode=SSC mode 1, and the analytics in the first response is DL 20 Mbps, 10 ms, the first communication device may know that when the PDU session in SSC mode 1 is used for accessing an application server of Tencent, a performance index that can be achieved is a downlink rate of 20 Mbps and a delay of 10 milliseconds.

In some implementations, after receiving the first response, the first communication device may further perform a UE route selection policy (UE Route Selection Policy, URSP) rule adjustment operation according to the analytics in the first response, to generate an intelligent URSP rule, and send the intelligent URSP rule to the terminal. It is hoped that the terminal matches traffic of an application to an appropriate PDU session according to the intelligently designed URSP rule. A PDU session parameter of the appropriate PDU session is indicated or specified by an RSC in an RSD selected by the terminal for the application in the intelligent URSP rule, and the PDU session has performance that can achieve better application or user experience.

In some implementations, the foregoing URSP rule adjustment operation performed by the first communication device may include at least one of the following:
modifying a Route Selection Descriptor (RSD) priority;
modifying a Route Selection Component (RSC) in the RSD; or
generating a new URSP rule.

When in the first request, performance after at least one RSC combination is requested, if a combination of the group of RSCs happens to be the same as an RSC combination in an RSD in the URSP rule, in this case, the first request is equivalent to requesting to obtain an analytics or performance analysis of one RSD. Therefore, the PCF may request performance of a plurality of at least one group of RSC combinations, and then cach of the at least one group of RSC combinations is equivalent to an RSD under a URSP rule. In this way, the PCF (the first communication device) can obtain an analytics or performance analysis of a plurality of RSDs under one URSP rule, and then compare a performance difference of cach RSD according to the performance analysis, thereby adjusting a priority. For the analytics or performance analysis, an RSD that indicates better performance may be set to a higher priority, and otherwise, it may be set to a lower priority.

When performance after at least one RSC combination is requested in the first request, for example, if the analytics when the PDU session type (session type) is the IP type and when DNN1 is accessed are requested to be obtained at the same time, the performance will reflect performance or application experience that can be achieved when the PDU session type is the IP type and DNN1 is accessed. However, the PCF (the first communication device) may further use a control variable manner. To obtain performance when the PDU session type is the IP type and another DNN is accessed, the PCF (the first communication device) may send a first request again to request to obtain performance after at least one RSC combination. For example, if the PDU session type is the IP type and DNN2 is accessed, in the first response, the performance will reflect performance or application experience that can be achieved when the PDU session type is the IP type and DNN2 is accessed. If (for an application, or a terminal, or any application) the performance of the PDU session type being IP type+DNN1 is higher than the performance of the PDU session type being IP type+DNN2, it indicates that the combination of the PDU session type being IP type and DNN1 is more suitable for the URSP rule. Therefore, after the PCF receives the analytics of the first response, actions may be taken that: DNN2 is changed to DNN1 when a combination of the PDU session type being IP type and the DNN is included in a certain RSD in the URSP rule. In this method, different RSC combinations are requested, then performance of the different combinations is analyzed, and then how to select another parameter is determined if a certain parameter, such as a session type, is fixed in the different combinations.

A new URSP rule may also be generated. A method is to request performance after at least one RSC combination. If the RSC combination is not included in any RSD in the URSP rule, that is, there is no RSD formed after such RSC combination in the URSP rule, and performance after the RSC combination is relatively good, in this case, the PCF may consider making the RSC combination generate a new URSP rule, or generate a new RSD under a traffic descriptor.

Modifying the priority of the RSD includes increasing a priority of a certain RSD or decreasing a priority of a certain RSD.

The RSD is an RSD to which each RSC in the at least one RSC in the first request corresponds or belongs; or, the RSD is an RSD which a combination of all RSCs in the at least one RSC in the first request corresponds to or belongs to or constitutes; or, the RSD is an RSD to which each RSC in the at least one RSC corresponding to the analytics in the first response corresponds or belongs; or, the RSD is an RSD which a combination of all RSCs in the at least one RSC corresponding to the analytics in the first response corresponds to or belongs to or constitutes;
a description is made as follows by taking an example:
for example, under a certain traffic descriptor, there are two RSDs, and parameters of slices of the RSDs are different.

| | |
|---|---|
| Rule Precedence = 1 | Route Selection Descriptor Precedence = 1 |
| Traffic Descriptor: | Network Slice Selection: S-NSSAI-a |
| Application descriptor = App1 | SSC mode selection: SSC mode 1 |
| | Route Selection Descriptor Precedence = 2 |
| | Network Slice Selection: S-NSSAI-b |
| | SSC mode selection: SSC mode 1 |

In this case, the PCF (the first communication device) sends a first request. The first request is an analytics when it is an S-NSSAI-a slice and the SSC mode is 1. In this case, the requested analytics is equivalent to an analytics of an RSD whose RSD priority is 1; and then, the PCF sends a request again, the first request is an analytics when it is an S-NSSAI-b slice and the SSC mode is 1, in this case, the requested analytics is equivalent to an analytics of an RSD whose RSD priority is 2.

If performance indicated by the analytics when it is the S-NSSAI-b slice and the SSC mode is 1 is better than performance indicated by the analytics when it is the S-NSSAI-a slice and the SSC mode is 1, for example, an uplink rate is better, it indicates that the RSD2 is better than the RSD1, so the PCF (the first communication device) may adjust priorities of the two RSDs, the priority of the RSD2 is adjusted to be higher than the priority of the RSD1, and an adjustment result is as follows:

| | |
|---|---|
| Rule Precedence = 1 | Route Selection Descriptor Precedence = 1 |
| Traffic Descriptor: | Network Slice Selection: S-NSSAI-b |
| Application descriptor = App1 | SSC mode selection: SSC mode 1 |
| | Route Selection Descriptor Precedence = 2 |
| | Network Slice Selection: S-NSSAI-a |
| | SSC mode selection: SSC mode 1 |

Modifying the RSC in the RSD includes modifying a value of a parameter of an RSC in a certain RSD; and
the RSD is an RSD to which each RSC in the at least one RSC in the first request corresponds or belongs; or, the RSD is an RSD which a combination of all RSCs in the at least one RSC in the first request corresponds to or belongs to or constitutes; or, the RSD is an RSD to which each RSC in the at least one RSC corresponding to the analytics in the first response corresponds or belongs; or, the RSD is an RSD which a combination of all RSCs in the at least one RSC corresponding to the analytics in the first response corresponds to or belongs to or constitutes; In addition, a parameter of an RSC used for replacement is also certainly included in the at least one RSC indicated by the first request, or in the at least one RSC or the RSC combination corresponding to the analytics of the first response.

For example, when it is the S-NSSAI-b slice and the SSC mode is 1, performance indicated by an analytics of this combination is better than performance indicated by an analytics of a combination of the S-NSSAI-a slice and the SSC mode being 1, for example, the uplink rate is better, it indicates that when the SSC mode is 1, the performance that can be achieved by using the S-NSSAI-b slice is better, or the performance obtained after using the combination of the S-NSSAI-b slice and SSC mode 1 is better, so the PCF (the first communication device) may adjust the RSC, for example, the slice S-NSSAI-a with the RSD priority being 1 is replaced with S-NSSAI-b. An adjustment result thereof is also shown in the following table.

| | |
|---|---|
| Rule Precedence = 1 | Route Selection Descriptor Precedence = 1 |
| Traffic Descriptor: | Network Slice Selection: S-NSSAI-b |
| Application descriptor = App1 | SSC mode selection: SSC mode 1 |

Modifying the RSC includes replacing an RSC in an RSD in the URSP rule with the at least one RSC corresponding to the analytics in the first response.

Therefore, it can be concluded herein that after receiving the first response, the first communication device may have the following operations:
performance after a plurality RSC combinations may be requested at the same time, then each RSC combination is the same as the RSC included in a certain RSD in the URSP rule, in this case, the first communication device (the PCF) requests to obtain an analytics of different RSDs in the URSP rule, and the priority of the RSD may be modified according to strengths and weaknesses of the performance indicated by cach analytics; and
in addition, the first communication device (the PCF) may also request performance after a plurality of RSC combinations at the same time, and may also attempt many times to fix several RSC parameters and change any parameter (for example, the SSC mode, the DNN, the slice, the access mode, etc.) for a difference or change of the performance after the combination. The purpose of doing like this is to see performance when a certain group of RSDs is used and meanwhile see an influence on the performance when other parameters in the group of RSDs are not changed and only parameters such as the slice and the SSC mode are changed. Performance of the entire RSD is a result of comprehensive use of a plurality of RSCs under the RSD. For example, for a certain PDU session, the performance of using both the slice S-NSSAI-a and DNN1 is not just overlaying of obtained performance of S-NSSAI-a and obtained performance of DNN1, or rather, the PCF requests the NWDAF (the second communication device) to provide an analytics, and this analytics is an analytics or performance after the PDU session uses both S-NSSAI-a and DNN1. In this way, a performance change or difference after one RSC in the RSDs is modified, or a profound influence on the performance after the entire RSC combination when other RSC parameters are not changed, only one of the RSC parameters is modified may be seen. Therefore, it may further be used for modifying a certain RSC in RSDs.

In the embodiment of the present application, when intending to obtain the analytics, the first communication device may send the first request including at least one piece of information, the at least one piece of information includes at least one RSC and/or at least one PDU session parameter, and an analytics corresponding to each RSC/PDU session parameter, and/or the corresponding analytics once the plurality of RSCs/PDU session parameters are combined may be obtained based on the at least one piece of information. In this way, the corresponding analytics may be obtained through one or a combination of more of RSCs/PDU session parameters, so the certain limitations may be canceled, so that obtaining of the analytics is more flexible and the demand for obtaining the analytics is met.

As shown in FIG. 4, an embodiment of the present application provides a method 400 for obtaining an analytics. The method may be performed by a second communication device, in other words, the method for obtaining the analytics may be performed by software or hardware installed in a second communication terminal, and the method for obtaining the analytics includes the following steps.

S402: a first request is received by the second communication device, where the first request includes at least one piece of information, the at least one piece of information includes at least one RSC and/or at least one PDU session parameter, and the first request is used for requesting to obtain an analytics.

When another communication device intends to obtain the analytics, the second communication device may receive the first request used for requesting to obtain the analytics. The second communication device may be an NWDAF.

In some implementations, the second communication device receiving the first request may be that the second communication device receives the first request from a first communication device. That is, when intending to obtain the analytics, the first communication device may send the first request to the second communication device. In this case, the second communication device may receive the first request from the first communication device. The first communication device may be a PCF, an AM-PCF, or an SM-PCF.

In an implementation, the first request may be at least one of the following:
Nnwdaf_AnalyticsSubscription_Subscribe (analytics subscription); or
Nnwdaf_AnalyticsInfo_Request (analytics information request).

The first request includes at least one piece of information, and the at least one piece of information includes at least one RSC or at least one PDU session parameter. That is, the first request includes at least one RSC and/or at least one PDU session parameter. The at least one RSC or the at least one PDU session parameter may include at least one of the following:
a PDU session type;
an SSC mode;
an access type;
S-NSSAI; or
DNN.

The PDU session type may include at least one of the following:
an Ethernet type;
unstructured;
an IPV4 type;
an IPV6 type; or
an IPV4V6 type.

The SSC mode may include at least one of the following:
SSC mode 1;
SSC mode 2; or
SSC mode 3.

The access type may include at least one of the following:
WLAN; in some implementations, in a case that the access type is WLAN, the first request may further include at least one of SSID, BSSID or HESSID;
PLMN ID;
5G;
4G;
an NG-RAN;
an E-UTRAN;
trusted WLAN; or
multi-access.

In the embodiment of the present application, in a case that the first request includes at least one piece of information, the analytics that the first request is used for requesting to obtain may include at least one of the following:
an analytics corresponding to each piece of information among the at least one piece of information; or
a corresponding analytics once all information among the at least one piece of information is combined.

Each piece of information among the at least one piece of information is each RSC in the foregoing at least one RSC and/or each PDU session parameter in the at least one PDU session parameter, and all information among the at least one piece of information is all RSCs in the foregoing at least one RSC and/or all PDU session parameters in the at least one PDU session parameter.

In some implementations, the analytics corresponding to each piece of information among the at least one piece of information may include at least one of the following:
an analytics corresponding to each RSC in the at least one RSC; or
an analytics corresponding to each PDU session parameter in the at least one PDU session parameter.

The corresponding analytics once all information in the at least one piece of information is combined may include at least one of the following:
a corresponding analytics once all RSCs in the at least one RSC are combined; or
a corresponding analytics once all PDU session parameters in the at least one PDU session parameter are combined.

For convenience of description, an example in which the at least one piece of information included in the first request is at least one RSC may be used for description below. The at least one RSC included in the first request in the following embodiments may be replaced with the at least one PDU session parameter included in the first request, or replaced with the at least one PDU session parameter and the at least one RSC included in the first request.

In a case that the first request includes one RSC, the first request is used for requesting to obtain an analytics corresponding to the one RSC. In a case that the first request includes a plurality of RSCs, the first request is used for requesting to obtain the analytics corresponding respectively to cach RSC in the plurality of RSCs, and/or, the analytics corresponding to a combination of the plurality of RSCs. Reference may be made to the embodiment shown in FIG. 2 for details, and a description for example is not repeated here.

In some implementations, in a case that the first request includes at least one piece of information, the first request may further include second information, and the second information is used for indicating at least one of the following:
obtaining the analytics corresponding to each piece of information among the at least one piece of information; or
obtaining the corresponding analytics once all information among the at least one piece of information is combined.

That is, an example in which the at least one piece of information is at least one RSC is used, the second communication device may also receive second information while receiving the first request (including at least one RSC), and the second communication device may determine, based on the second information, which analytics the first request specifically requests to obtain.

In an implementation, the second communication device needs to understand the indication information (namely, the second information), corresponding data is acquired according to the indication information, and then an analytics is provided for the first communication device. The indication information may be designed into various character strings, for example, the indication is set with a bit 1, and if an input is 0, this indication is requesting to obtain an analytics corresponding to each RSC in the at least one RSC; and if an input is 1, this indication is requesting to obtain the corresponding analytics once all RSCs in the at least one RSC are combined. A specific design method is not limited here, but the indication information may indicate various cases and scenes, so as to obtain various types of analytics.

For example, in a case that the first request includes the PDU session type (an IP type), the SSC mode (SSC mode 3) and the second information:
if the second information is used for indicating to obtain the analytics corresponding to each RSC in the at least one RSC, the second communication device may determine that the first request is specifically used for requesting to obtain an analytics when a PDU session carries an application traffic and the PDU session type is the IP type, and an analytics when the PDU session carries the application traffic and the PDU session supports SSC mode 3; and
if the second information is used for indicating to obtain the corresponding analytics once all RSCs in the at least one RSC are combined, the second communication device may determine that the first request is specifically used for requesting to obtain an analytics when the PDU session carries the application traffic and the PDU session satisfies that: the type of the PDU session is the IP type and the SSC mode supported by the PDU session is SSC mode 3; and
if the second information is used for indicating to obtain the analytics corresponding to cach RSC in the at least one RSC and the corresponding analytics once all RSCs in the at least one RSC are combined, the second communication device may determine that the first request is specifically used for requesting to obtain the analytics when the PDU session carries the application traffic and the type of the PDU session is the IP type, the analytics when the PDU session carries the application traffic and the PDU session supports SSC mode 3, and the analytics when the PDU session carries the application traffic and the PDU session simultaneously satisfies that: the type of the PDU session is the IP type and the SSC mode of the PDU session is SSC mode 3.

In some implementations, in a case that the first request includes at least one piece of information, the first request may further include an application ID of a target application, and a method for determining the application ID may refer to the embodiment shown in FIG. 2, and a repeated description is omitted here.

In a case that the first request includes the application ID and the at least one piece of information, the analytics that the first request is used for requesting to obtain may include at least one of the following:
a corresponding analytics once the application ID is combined with each piece of information among the at least one piece of information; or
a corresponding analytics once the application ID is combined with all information among the at least one piece of information.

In some implementations, the corresponding analytics once the application ID is combined with each piece of information among the at least one piece of information may include at least one of the following:
a corresponding analytics once the application ID is combined with each RSC in the at least one RSC; or
a corresponding analytics once the application ID is combined with each PDU session parameter in the at least one PDU session parameter.

The corresponding analytics once the application ID is combined with all information among the at least one piece of information may include at least one of the following:
a corresponding analytics once the application ID is combined with all RSCs in the at least one RSC; or
a corresponding analytics once the application ID is combined with all PDU session parameters in the at least one PDU session parameter.

Using an example in which the at least one piece of information is at least one RSC, in a case that the first request includes the application ID and the at least one RSC, the first request is used for requesting to obtain a corresponding analytics once the application ID is combined with each RSC respectively, and/or, a corresponding analytics once the application ID is combined with the at least one RSC. Reference may be made to the embodiment shown in FIG. 2, and a description for example is not repeated here.

In some implementations, in a case that the first request includes the application ID of the target application and at least one piece of information, the first request may further include third information, and the third information is used for indicating at least one of the following:
obtaining the corresponding analytics once the application ID is combined with each piece of information among the at least one piece of information; or
obtaining the corresponding analytics once the application ID is combined with all information among the at least one piece of information.

That is, an example in which the at least one piece of information is at least one RSC is used, while receiving the first request (including the application ID and the at least one RSC), the second communication device may further receive the third information, and the second communication device may determine, based on the third information, which analytics the first request specifically requests to obtain.

For example, in a case that the first request includes the application ID of the target application, the PDU session type (the IP type), the SSC mode (SSC mode 3), and the third information:
if the third information is used for indicating to obtain the analytics corresponding to the application ID and each RSC in the at least one RSC, the second communication device may determine that the first request is specifically used for requesting to obtain an analytics when the target application is carried under the PDU session and the type of the PDU session is the IP type, and an analytics when the target application is carried under the PDU session and the SSC mode of the PDU session is SSC mode 3;
if the third information is used for indicating to obtain the corresponding analytics once the application ID is combined with all RSCs in the at least one RSC, the second communication device may determine that the first request is specifically used for requesting to obtain an analytics when the target application is carried under the PDU session and the PDU session simultaneously satisfies that the session type is the IP type and the SSC mode is SSC mode 3; and
if the third information is used for indicating to obtain the analytics corresponding to the application ID and each RSC in the at least one RSC, and the corresponding analytics once the application ID is combined with all RSCs in the at least one RSC, the second communication device may determine that the first request is specifically used for requesting to obtain the analytics when the target application is carried under the PDU session and the type of the PDU session is the IP type, the analytics when the target application is carried under the PDU session and the SSC mode of the PDU session is SSC mode 3, and the analytics when the target application is carried under the PDU session and the PDU session simultaneously satisfies that the session type is the IP type and the SSC mode is SSC mode 3.

In some implementations, in a case that the first request includes the at least one RSC, the first request may further include a traffic descriptor parameter, and the traffic descriptor parameter may include at least one of the following:
connection capabilities (Connection Capabilities);
application descriptors (Application descriptors);
IP descriptors (IP descriptors);
non-IP descriptors (Non-IP descriptors);
a Fully Qualified Domain Name (FQDN), namely, domain descriptors (Application server Domain descriptors); or
DNN.

In a case that the first request includes the traffic descriptor parameter and at least one piece of information, the analytics that the first request is used for requesting to obtain may include at least one of the following:
a corresponding analytics once the traffic descriptor parameter is combined with each piece of information among the at least one piece of information; or
a corresponding analytics once the traffic descriptor parameter is combined with all information among the at least one piece of information.

In some implementations, the corresponding analytics once the traffic descriptor parameter is combined with each piece of information among the at least one piece of information may include at least one of the following:
a corresponding analytics once the traffic descriptor parameter is combined with cach RSC in the at least one RSC; or
a corresponding analytics once the traffic descriptor parameter is combined with cach PDU session parameter in the at least one PDU session parameter.

The corresponding analytics once the traffic descriptor parameter is combined with all information among the at least one piece of information may include at least one of the following:
a corresponding analytics once the traffic descriptor parameter is combined with all RSCs in the at least one RSC; or
a corresponding analytics once the traffic descriptor parameter is combined with all PDU session parameters in the at least one PDU session parameter.

That is, using an example in which the at least one piece of information is at least one RSC, in a case that the first request includes the traffic descriptor parameter and one RSC, the first request is used for requesting to obtain a corresponding analytics once the traffic descriptor parameter is combined with the one RSC. In a case that the first request includes the traffic descriptor parameter and a plurality of RSCs, the first request is used for requesting to obtain the corresponding analytics once the traffic descriptor parameter is combined with each RSC respectively, and/or, a corresponding analytics once the traffic descriptor parameter is combined with the plurality of RSCs. Reference may be made to the embodiment shown in FIG. 2 for details, and a description for example is not repeated here.

In some implementations, in a case that the first request includes the traffic descriptor parameter and at least one piece of information, the first request may further include fourth information, and the fourth information is used for indicating at least one of the following:
obtaining the corresponding analytics once the traffic descriptor parameter is combined with each piece of information among the at least one piece of information; or
obtaining the corresponding analytics once the traffic descriptor parameter is combined with all information among the at least one piece of information.

That is, an example in which the at least one piece of information is at least one RSC is used. While receiving the first request (including the traffic descriptor parameter and the at least one RSC), the second communication device may further receive fourth information, and the second communication device may determine, based on the fourth information, which analytics the first request specifically requests to obtain.

For example, in a case that the first request includes the DNN, the PDU session type (the IP type), the SSC mode (SSC mode 1) and the fourth information:
if the fourth information is used for indicating to obtain the analytics corresponding to the traffic descriptor parameter and cach RSC in the at least one RSC, the second communication device may determine that the first request is specifically used for requesting to obtain an analytics when the DNN is accessed and the type of the PDU session that accesses the DNN is the IP type and an analytics when the DNN is accessed and the SSC mode of the PDU session that accesses the DNN is SSC mode 1;
if the fourth information is used for indicating to obtain the corresponding analytics once the traffic descriptor parameter is combined with all RSCs in the at least one RSC, the second communication device may determine that the first request is specifically used for requesting to obtain an analytics when the DNN is accessed, and the PDU session that accesses the DNN simultaneously satisfies that the session type is the IP type and the SSC mode is SSC mode 1; and
if the fourth information is used for indicating to obtain the analytics corresponding to the traffic descriptor parameter and each RSC in the at least one RSC and the corresponding analytics once the traffic descriptor parameter is combined with all RSCs in the at least one RSC, the second communication device may determine that the first request is specifically used for requesting to obtain an analytics when the DNN is accessed and the type of the PDU session that accesses the DNN is the IP type, an analytics when the DNN is accessed and the SSC mode of the PDU session that accesses the DNN is SSC mode 1, and an analytics when the DNN is accessed and the PDU session that accesses the DNN simultaneously satisfies that the session type is the IP type and the SSC mode is SSC mode 1.

S404: the second communication device determines the analytics according to the first request.

After receiving the first request, the second communication device may determine, according to the first request, the analytics that the first request requests to obtain. In some implementations, the second communication device may acquire target data according to the first request, and then generate a corresponding analytics according to the acquired target data. In a case that information included in the first request is different, the target data acquired by the second communication device is different, an example in which the at least one piece of information in the first request is at least one RSC is used, and the following several cases may be included specifically.

First case: the first request includes at least one RSC.

In the first case, the second communication device may acquire target data corresponding to each RSC in the at least one RSC, and/or, corresponding target data once all RSCs in the at least one RSC are combined.

For example, in a case that the first request includes the PDU session type (the IP type), the second communication device may acquire performance data (namely, the target data) when a PDU session carries a traffic of one or more terminals and the type of the PDU session is the IP type, the performance data may be data of all terminals or any terminal when the type of the PDU session is the IP type, and a traffic of which application is carried by the PDU session of the IP type is of no interest; and
in a case that the first request includes the SSC mode (SSC mode 3), the second communication device may acquire performance data (namely, target data) when the PDU session carries a traffic of one or more terminals and the SSC mode of the PDU session is SSC mode 3, the performance data may be data of all terminals or any terminal when the PDU session is SSC mode 3, and a traffic of which application is carried by the PDU session in the SSC mode 3 is of no interest.

For another example:
in a case that the first request includes the PDU session type (the IP type) and the SSC mode (SSC mode 3), the second communication device may acquire the performance data when the PDU session carries the traffic of one or more terminals and the type of the PDU session is the IP type, the performance data when the PDU session carries the traffic of one or more terminals and the SSC mode of the PDU session is SSC mode 3, and/or, performance data when the PDU session carries the traffic of one or more terminals and this PDU session satisfies that: the type of the PDU session is the IP type and the SSC mode of the PDU session is SSC mode 3.

Second case: the first request includes at least one RSC and the second information.

In the first case, the second communication device may acquire corresponding target data according to the analytics that the second information indicates to obtain.

For example, in a case that the first request includes the PDU session type (the IP type), the SSC mode (SSC mode 3) and the second information:
if the second information is used for indicating to obtain the analytics corresponding to cach RSC in the at least one RSC, the second communication device may acquire the performance data when the PDU session carries the traffic of one or more terminals and the type of the PDU session is the IP type, and the performance data when the PDU session carries the traffic of one or more terminals and the SSC mode of the PDU session is SSC mode 3;
if the second information is used for indicating to obtain the corresponding analytics once all RSCs in the at least one RSC are combined, the second communication device may acquire the analytics or the performance data of the PDU session when the PDU session carries the traffic of one or more terminals, and this PDU session satisfies that: the type of the PDU session is the IP type and the SSC mode is SSC mode 3; and
if the second information is used for indicating to obtain the analytics corresponding to each RSC in the at least one RSC and the corresponding analytics once all RSCs in the at least one RSC are combined, the second communication device may acquire the performance data when the PDU session carries the traffic of one or more terminals and the type of the PDU session is the IP type, the performance data when the PDU session carries the traffic of one or more terminals and the SSC mode of the PDU session is SSC mode 3, and the performance data when the PDU session carries the traffic of one or more terminals, and the PDU session simultaneously satisfies that the PDU session type is the IP type, and the SSC mode of the PDU session is SSC mode 3.

Third case: the first request includes the application ID of the target application and at least one RSC.

In the third case, the second communication device may acquire target data corresponding respectively to the application ID and each RSC in the at least one RSC, and/or, corresponding target data once the application ID is combined with all RSCs in the at least one RSC.

For example:
in a case that the first request includes the application ID of the target application and the PDU session type (the IP type), the second communication device may acquire performance data when a PDU session carries an application traffic indicated by the application ID and the type of the PDU session is the IP type;
in a case that the first request includes the application ID of the target application and the SSC mode (SSC mode 3), the second communication device may acquire performance data when the PDU session carries the application traffic indicated by the application ID and the SSC mode of the PDU session is SSC mode 3;
in a case that the first request includes the application ID of the target application and an access type (non-3GPP, a WLAN access), the second communication device may acquire performance data when the PDU session carries the application traffic indicated by the application ID and the access type of the PDU session is WLAN; and
in a case that the first request includes the application ID of the target application and the DNN, the second communication device may acquire performance data when the PDU session carrying the application traffic indicated by the application ID access an application through the DNN.

For another example:
in a case that the first request includes the application ID of the target application, the PDU session type (the IP type) and the SSC mode (SSC mode 3), the second communication device may acquire the performance data when the PDU session carries the application traffic indicated by the application ID and the type of the PDU session is the IP type, the performance data when the PDU session carries the application traffic indicated by the application ID and the SSC mode of the PDU session is SSC mode 3, and/or, the performance data when the PDU session carries the application traffic indicated by the application ID, and the PDU session simultaneously satisfies that: the PDU session is the IP type and is SSC mode 3.

Fourth case: the first request includes the application ID of the target application, at least one RSC and the third information.

In the fourth case, the second communication device may acquire corresponding target data according to the analytics that the third information indicates to obtain.

For example, in a case that the first request includes the application ID of the target application, the PDU session type (the IP type) and the SSC mode (SSC mode 3) and the third information:
if the third information is used for indicating to obtain the corresponding analytics once the application ID is combined with each RSC in the at least one RSC, the second communication device may acquire the performance data when the PDU session carries the application traffic indicated by the application ID and the type of the PDU session is the IP type, and the performance data when the PDU session carries the application traffic indicated by the application ID and the SSC mode of the PDU session is SSC mode 3;
if the third information is used for indicating to obtain the corresponding analytics once the application ID is combined with all RSCs in the at least one RSC, the second communication device may acquire the performance data when the PDU session carries the application traffic indicated by the application ID and the PDU session simultaneously satisfies that the PDU session is the IP type and is SSC mode 3; and
if the third information is used for indicating to obtain the corresponding analytics once the application ID is combined with each RSC in the at least one RSC and the corresponding analytics once the application ID is combined with all RSCs in the at least one RSC, the second communication device may acquire the performance data when the PDU session carries the application traffic indicated by the application ID and the type of the PDU session is the IP type, the performance data when the PDU session carries the application traffic indicated by the application ID and the SSC mode of the PDU session is SSC mode 3, and the performance data when the PDU session carries the application traffic indicated by the application ID and the PDU session simultaneously satisfies that the PDU session is the IP type and is SSC mode 3.

Fifth case: the first request includes the traffic descriptor parameter and the at least one RSC.

In the fifth case, the second communication device may acquire corresponding target data once the traffic descriptor parameter is combined with each RSC in the at least one RSC, and/or, corresponding target data once the traffic descriptor parameter is combined with all RSCs in the at least one RSC.

For example:
in a case that the first request includes an IP/Non-IP descriptor and the PDU session type (the IP type), the second communication device may acquire performance data when a PDU session carries a traffic of one or more terminals and accesses an application server corresponding to the IP/Non-IP descriptor and the type of the PDU session is the IP type;
in a case that the first request includes connection capabilities (“ims”, “mms”, “internet”), the application ID of the target application and the SSC mode (SSC mode 1), the second communication device may acquire performance data when a PDU session carries a traffic of one or more terminals in an access mode such as an ims access and the SSC mode of the PDU session is SSC mode 1; and
in a case that the first request includes the DNN and the access type (non-3GPP, WLAN, SSID=AAA), the second communication device may acquire performance data when a PDU session carries the traffic of one or more terminals and accesses the DNN, an access type of the PDU session is WLAN, and WLAN SSID=AAA.

For another example:
in a case that the first request includes the DNN, the PDU session type (the IP type) and the SSC mode (SSC mode 1), the second communication device may acquire the performance data when the PDU session carries the traffic of one or more terminals and accesses the DNN and the type of the PDU session is the IP type, the performance data when the PDU session carries the traffic of one or more terminals and accesses the DNN and the PDU session is SSC mode 1, and/or, the performance data when the PDU session carries the traffic of one or more terminals and accesses the DNN and the PDU session simultaneously satisfies that the type of the PDU session is the IP type and the SSC mode of the PDU session is SSC mode 1.

Sixth case: the first request includes the traffic descriptor parameter, the at least one RSC, and the fourth information.

In the sixth case, the second communication device may acquire corresponding target data according to the analytics that the fourth information indicates to obtain.

For example, in a case that the first request includes the DNN, the PDU session type (the IP type), the SSC mode (SSC mode 1) and the fourth information:
if the fourth information is used for indicating to obtain the analytics corresponding to the traffic descriptor parameter and cach RSC in the at least one RSC, the second communication device may acquire the performance data when the PDU session carries the traffic of one or more terminals and accesses the DNN and the type of the PDU session is the IP type and the performance data when the PDU session carries the traffic of one or more terminals and accesses the DNN and the SSC mode of the PDU session is SSC mode 1;
if the fourth information is used for indicating to obtain the corresponding analytics once the traffic descriptor parameter is combined with all RSCs in the at least one RSC, the second communication device may acquire the performance data when the PDU session carries the traffic of one or more terminals and accesses the DNN and the PDU session simultaneously satisfies that the type of the PDU session is the IP type and the SSC mode of the PDU session is SSC mode 1; and
if the fourth information is used for indicating to obtain the corresponding analytics once the traffic descriptor parameter is combined with each RSC in the at least one RSC and the corresponding analytics once the traffic descriptor parameter is combined with all RSCs in the at least one RSC, the second communication device may acquire the performance data when the PDU session carries the traffic of one or more terminals and accesses the DNN and the type of the PDU session is the IP type, the performance data when the PDU session carries the traffic of one or more terminals and accesses the DNN and the PDU session is SSC mode 1, and the performance data when the PDU session carries the traffic of one or more terminals and accesses the DNN and the PDU session simultaneously satisfies that the type of the PDU session is the IP type and the SSC mode of the PDU session is SSC mode 1.

After acquiring the foregoing performance data or acquiring the related data according to the first request by the second communication device, the analytics may be generated through a built-in algorithm or procedure. The analytics is used for being sent to the first communication device through the first response.

S406: the first response is sent by the second communication device, where the first response includes the analytics.

After determining the analytics, the second communication device may carry the analytics in the first response and send the first response. In some implementations, the second communication device sending the first response may be that the second communication device sends the first response to the first communication device, namely, in a case that the second communication device receives the first request from the first communication device, the second communication device may send the first response to the first communication device when sending the first response.

In the embodiment of the present application, when intending to obtain the analytics, the first communication device may send the first request including at least one piece of information, the at least one piece of information includes at least one RSC and/or at least one PDU session parameter, and an analytics corresponding to each RSC/PDU session parameter, and/or the corresponding analytics once the plurality of RSCs/PDU session parameters are combined may be obtained based on the at least one piece of information. In this way, the corresponding analytics may be obtained through one or a combination of more of RSCs/PDU session parameters, so the certain limitations may be canceled, so that obtaining of the analytics is more flexible and the demand for obtaining the analytics is met.

An executive body for the method for obtaining the analytics provided by the embodiment of the present application may be an apparatus for obtaining the analysis result. In the embodiment of the present application, an example in which the method for obtaining the analytics is performed by obtaining of the analytics is used for describing the apparatus for obtaining the analytics provided by the embodiment of the present application.

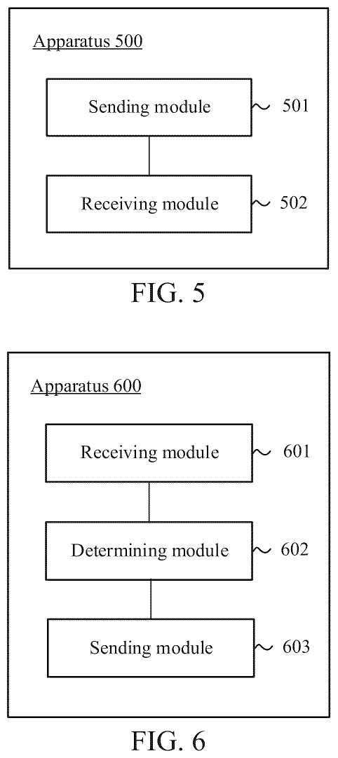

FIG. 5 is a schematic structural diagram of an apparatus for obtaining an analytics according to an embodiment of the present application. The apparatus may correspond to a first communication device in another embodiment. As shown in FIG. 5, the apparatus 500 includes the following modules.

A sending module 501 is configured to send a first request, where the first request includes at least one piece of information, the at least one piece of information includes at least one RSC and/or at least one PDU session parameter, and the first request is used for requesting to obtain an analytics.

A receiving module 502 is configured to receive a first response, where the first response includes the analytics.

The analytics includes at least one of the following:
an analytics corresponding to each piece of information among the at least one piece of information; or
a corresponding analytics once all information among the at least one piece of information is combined.

In some implementations, the analytics corresponding to each piece of information among the at least one piece of information includes at least one of the following:
an analytics corresponding to each RSC in the at least one RSC; or
an analytics corresponding to each PDU session parameter in the at least one PDU session parameter.

The corresponding analytics once all information among the at least one piece of information is combined includes at least one of the following:
a corresponding analytics after all RSCs in the at least one RSC are combined; or
a corresponding analytics once all PDU session parameters in the at least one PDU session parameter are combined.

In some implementations, the apparatus 500 further includes an adjusting module 503, and the adjusting module 503 is configured to:
perform a UE Route Selection Policy (URSP) rule adjustment operation according to the analytics, where the URSP rule adjustment operation includes at least one of the following:
modifying a Route Selection Descriptor (RSD) priority;
modifying an RSC in the RSD; or
generating a new URSP rule.

In some implementations, the sending module 501 is configured to:
send the first request to a second communication device.

The receiving module 502 is configured to:
receive the first response from the second communication device, where the analytics is determined by the second communication device according to the first request.

In some implementations, the at least one RSC includes at least one of the following:
a PDU session type;
a Session and Service Continuity (SSC) mode;
an access type;
Single Network Slice Selection Assistance Information (S-NSSAI); or
a Data Network Name (DNN).

The at least one PDU session parameter includes at least one of the following:
a PDU session type;
an SSC mode;
an access type;
S-NSSAI; or
DNN.

In some implementations, the PDU session type includes at least one of the following:
an Ethernet type;
unstructured;
an Internet protocol fourth version (IPV4) type;
an Internet protocol sixth version (IPV6) type; or
an IPV4V6 type.

In some implementations, the SSC mode includes at least one of the following:
SSC mode 1;
SSC mode 2; or
SSC mode 3.

In some implementations, the access type includes at least one of the following:
Wireless Local Area Networks (WLAN);
a Public Land Mobile Network (PLMN) ID;
5G;
4G;
an NG Radio Access Network (NG-RAN);
an Evolved Universal mobile telecommunications system Terrestrial Radio Access Network (E-UTRAN);
trusted WLAN; or
multi-access.

In some implementations, the first request includes second information, and the second information is used for indicating at least one of the following:
obtaining the analytics corresponding to each piece of information among the at least one piece of information; or
obtaining the corresponding analytics once all information among the at least one piece of information is combined.

In some implementations, the first request further includes an application ID of the target application, and the analytics that the first request is used for requesting to obtain includes at least one of the following:
a corresponding analytics once the application ID is combined with each piece of information among the at least one piece of information; or
a corresponding analytics once the application ID is combined with all information among the at least one piece of information.

In some implementations, the sending module 501 is further configured to:
send a second request, where the second request includes a traffic descriptor parameter, and the second request is used for requesting to obtain the application ID of the target application corresponding to the traffic descriptor parameter.

The receiving module 502 is further configured to:
receive a second response, where the second response includes the application ID of the target application.

In some implementations, the traffic descriptor parameter includes at least one of the following:
connection capabilities;
application descriptors;
IP descriptors;
non-IP descriptors;
a FQDN; or
DNN.

In some implementations, the sending module 501 is configured to:
send the second request to a third communication device.

The receiving module 502 is configured to:
receive the second response from the third communication device, where the application ID of the target application is determined by the third communication device according to the traffic descriptor parameter and a preset mapping relationship, and the mapping relationship is a mapping relationship between the traffic descriptor parameter and the application ID.

In some implementations, the mapping relationship is obtained by the third communication device from a fourth communication device, and the mapping relationship is provided by a fifth communication device and stored by the fifth communication device into the fourth communication device through the third communication device; or,
the mapping relationship is provided by the third communication device.

In some implementations, the first request includes third information, and the third information is used for indicating at least one of the following:
obtaining the corresponding analytics once the application ID is combined with each piece of information among the at least one piece of information; or
obtaining the corresponding analytics once the application ID is combined with all information among the at least one piece of information.

In some implementations, the first request further includes a traffic descriptor parameter, and the analytics that the first request is used for requesting to obtain includes at least one of the following:
a corresponding analytics once the traffic descriptor parameter is combined with each piece of information among the at least one piece of information; or
a corresponding analytics once the traffic descriptor parameter is combined with all information among the at least one piece of information.

In some implementations, the first request includes fourth information, and the fourth information is used for indicating at least one of the following:
obtaining the corresponding analytics once the traffic descriptor parameter is combined with each piece of information among the at least one piece of information; or
obtaining the corresponding analytics once the traffic descriptor parameter is combined with all information among the at least one piece of information.

The apparatus 500 according to the embodiment of the present application may refer to corresponding procedures of the method 200 in the embodiment of the present application, moreover, each unit/module in the apparatus 500 and the foregoing other operations and/or functions are respectively for implementing corresponding procedures in the method 200, and can achieve the same or equivalent technical effects, and details are omitted here for being concise.

FIG. 6 is a schematic structural diagram of an apparatus for obtaining an analytics according to an embodiment of the present application. The apparatus may correspond to a second communication device in another embodiment. As shown in FIG. 6, the apparatus 600 includes the following modules.

A receiving module 601 is configured to receive a first request, where the first request includes at least one piece of information, the at least one piece of information includes at least one RSC and/or at least one PDU session parameter, and the first request is used for requesting to obtain an analytics.

A determining module 602 is configured to determine the analytics according to the first request.

A sending module 603 is configured to send a first response, where the first response includes the analytics.

The analytics includes at least one of the following:
an analytics corresponding to each piece of information among the at least one piece of information; or
a corresponding analytics once all information among the at least one piece of information is combined.

In some implementations, the analytics corresponding to each piece of information among the at least one piece of information includes at least one of the following:
an analytics corresponding to each RSC in the at least one RSC; or
an analytics corresponding to each PDU session parameter in the at least one PDU session parameter.

The corresponding analytics once all information among the at least one piece of information is combined includes at least one of the following:
a corresponding analytics once all RSCs in the at least one RSC are combined; or
a corresponding analytics once all PDU session parameters in the at least one PDU session parameter are combined.

In some implementations, the receiving module 601 is configured to:
receive the first request from a first communication device.

The sending module 603 is configured to:
send the first response to the first communication device.

In some implementations, the at least one RSC includes at least one of the following:
a PDU session type;
an SSC mode;
an access type;
S-NSSAI; or
DNN.

The at least one PDU session parameter includes at least one of the following:
a PDU session type;
an SSC mode;
an access type;
S-NSSAI; or
DNN.

In some implementations, the PDU session type includes at least one of the following:
an Ethernet type;
unstructured;
an IPV4 type;
an IPV6 type; or
an IPV4V6 type.

In some implementations, the SSC mode includes at least one of the following:
SSC mode 1;
SSC mode 2; or
SSC mode 3.

In some implementations, the access type includes at least one of the following:
WLAN;
a PLMN ID;
5G;
4G;
an NG-RAN;
an E-UTRAN;
trusted WLAN; or
multi-access.

In some implementations, the first request includes second information, and the second information is used for indicating at least one of the following:
obtaining the analytics corresponding to each piece of information among the at least one piece of information; or
obtaining the corresponding analytics once all information among the at least one piece of information is combined.

In some implementations, the first request further includes an application ID of the target application, and the analytics that the first request is used for requesting to obtain includes at least one of the following:
a corresponding analytics once the application ID is combined with each piece of information among the at least one piece of information; or
a corresponding analytics once the application ID is combined with all information among the at least one piece of information.

In some implementations, the first request includes third information, and the third information is used for indicating at least one of the following:
obtaining the corresponding analytics once the application ID is combined with each piece of information among the at least one piece of information; or
obtaining the corresponding analytics once the application ID is combined with all information among the at least one piece of information.

In some implementations, the first request further includes a traffic descriptor parameter, and the analytics that the first request is used for requesting to obtain includes at least one of the following:
a corresponding analytics once the traffic descriptor parameter is combined with each piece of information among the at least one piece of information; or
a corresponding analytics once the traffic descriptor parameter is combined with all information among the at least one piece of information.

In some implementations, the first request includes fourth information, and the fourth information is used for indicating at least one of the following:
obtaining the corresponding analytics once the traffic descriptor parameter is combined with each piece of information among the at least one piece of information; or
obtaining the corresponding analytics once the traffic descriptor parameter is combined with all information among the at least one piece of information.

In some implementations, the traffic descriptor parameter includes at least one of the following:
connection capabilities;
application descriptors;
IP descriptors;
non-IP descriptors;
FQDN; or.
DNN.

In some implementations, the determining module 602 is configured to:
acquire target data according to the first request; and
generate the analytics according to the target data.

The apparatus 600 according to the embodiment of the present application may refer to corresponding procedures of the method 400 in the embodiment of the present application, moreover, cach unit/module in the apparatus 600 and the foregoing other operations and/or functions are respectively for implementing corresponding procedures in the method 400, and can achieve the same or equivalent technical effects, and details are omitted here for being concisc.

The apparatus for obtaining the analytics in the embodiment of the present application may be an electronic device, for example, an electronic device having an operating system, or a component in an electronic device, such as an integrated circuit or a chip. The electronic device may be a terminal, or may be another device other than a terminal. Exemplarily, the terminal may include but is not limited to the types of the above listed terminals 11, and the another device may be a server, a Network Attached Storage (NAS), etc., and the embodiment of the present application does not make a specific limitation.

The apparatuses for obtaining the analytics provided by the embodiments of the present application are capable of implementing the procedures implemented in the method embodiments of FIG. 2 and FIG. 4, with the same technical effect achieved. To avoid repetitions, details are not described here again.

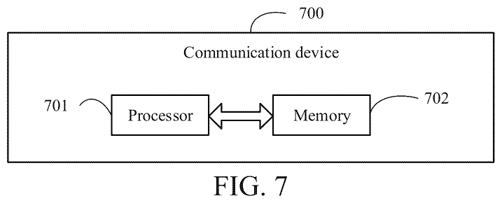

In some implementations, as shown in FIG. 7, an embodiment of the present application further provides a communication device 700, including a processor 701 and a memory 702. The memory 702 stores a program or an instruction executable on the processor 701. For example, when the communication device 700 is a first communication device, the program or the instruction, when executed by the processor 701, implements steps of the above embodiment of the method for obtaining the analytics, and the same technical effects can be achieved. When the communication device 700 is a second communication device, the program or the instruction, when executed by the processor 701, implements steps of the embodiment of the method for obtaining the analytics, and the same technical effects can be achieved. To avoid repetitions, details are not described here again.

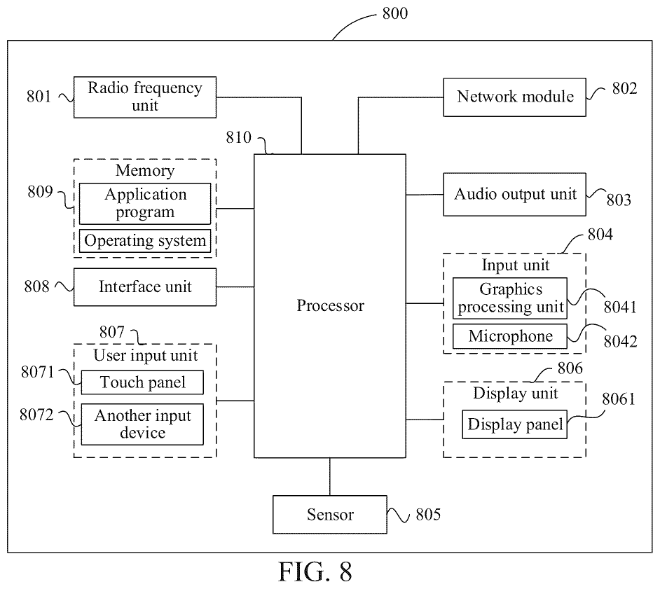

An embodiment of the present application further provides a communication device, including a processor and a communication interface. The communication interface is configured to send a first request, where the first request includes at least one piece of information, the at least one piece of information includes at least one RSC and/or at least one PDU session parameter, and the first request is used for requesting to obtain an analytics; and receive a first response, where the first response includes the analytics. The analytics includes at least one of the following: an analytics corresponding to each piece of information among the at least one piece of information; or a corresponding analytics once all information among the at least one piece of information is combined. In some implementations, the communication interface is configured to receive a first request, where the first request includes at least one piece of information, the at least one piece of information includes at least one RSC and/or at least one PDU session parameter, and the first request is used for requesting to obtain the analytics. The processor is configured to determine the analytics according to the first request, and the communication interface is configured to send a first response, where the first response includes the analytics. The analytics includes at least one of the following: an analytics corresponding to each piece of information among the at least one piece of information; or a corresponding analytics once all information among the at least one piece of information is combined. The embodiment of the communication device corresponds to the method embodiment on the first communication device or second communication device side, and all implementation processes and implementations of the method embodiment are applicable to the embodiment of the communication device, with the same technical effects achieved. In some implementations, FIG. 8 is a schematic structural diagram of hardware of a communication device implementing an embodiment of the present application.

The communication device 800 includes, but is not limited to: at least some of a radio frequency unit 801, a network module 802, an audio output unit 803, an input unit 804, a sensor 805, a display unit 806, a user input unit 807, an interface unit 808, a memory 809, a processor 810, etc.

A person of skill in the art may understand that the communication device 800 may further include a power supply (such as a battery) for supplying power to all the components. The power supply may be logically connected to the processor 810 through a power management system, thereby implementing functions, such as charging, discharging, and power consumption management, by using the power management system. A structure of the communication device shown in FIG. 8 constitutes no limitation on the communication device, and the communication device may include more or fewer components than those shown in the figure, or some components may be combined, or a different component deployment may be used, and details are omitted here.

It should be understood that, in the embodiment of the present application, the input unit 804 may include a Graphics Processing Unit (GPU) 8041 and a microphone 8042. The GPU 8041 processes image data of a static picture or a video obtained by an image capture apparatus (for example, a camera) in a video capture mode or image capture mode. The display unit 806 may include a display panel 8061. The display panel 8061 may be configured in a form of a liquid crystal display, an organic light-emitting diode, or the like. The user input unit 807 includes at least one of a touch panel 8071 and another input device 8072. The touch panel 8071 is also referred to as a touchscreen. The touch panel 8071 may include two parts: a touch detection apparatus and a touch controller. The another input device 8072 may include, but is not limited to, a physical keyboard, a functional key (such as a volume control key or a switch key), a track ball, a mouse, and a joystick. Details are not described here again.

In the embodiment of the present application, after receiving downlink data from a network-side device, the radio frequency unit 801 can transmit the data to the processor 810 for processing. In addition, the radio frequency unit 801 may send uplink data to the network-side device. Generally, the radio frequency unit 801 includes, but is not limited to, an antenna, an amplifier, a transceiver, a coupler, a low noise amplifier, a duplexer, and the like.

The memory 809 may be configured to store a software program or instruction and various data. The memory 809 may mainly include a first storage arca for program or instruction storage and a second storage area for data storage. The first storage area may store an operating system, an application program or instruction required by at least one function (for example, a sound playing function and an image playing function), and the like. Besides, the memory 809 may include a volatile memory or a non-volatile memory, or may include both the volatile memory and the non-volatile memory. The non-transitory memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), or a Direct Rambus RAM (DRRAM). The memory 809 in the embodiment of the present application includes, but is not limited to, these and any other suitable types of memories.

The processor 810 may include one or more processing units. In some implementations, the processor 810 integrates an application processor and a modem processor. The application processor mainly processes operations involving an operating system, a user interface, an application program, and the like, and the modem processor mainly processes wireless communication signals, such as a baseband processor. It may be understood that the foregoing modem processor may also not be integrated into the processor 810.

The radio frequency unit 801 is configured to send a first request, where the first request includes at least one piece of information, the at least one piece of information includes at least one RSC and/or at least one PDU session parameter, and the first request is used for requesting to obtain an analytics; and receive a first response, where the first response includes the analytics. The analytics includes at least one of the following: an analytics corresponding to cach piece of information among the at least one piece of information; or a corresponding analytics once all information among the at least one piece of information is combined.

In some implementations, the radio frequency unit 801 is configured to receive the first request, where the first request includes at least one piece of information, the at least one piece of information includes at least one RSC and/or at least one PDU session parameter, and the first request is used for requesting to obtain an analytics. The processor 810 is configured to determine the analytics according to the first request. The radio frequency unit 801 is configured to send a first response, where the first response includes the analytics. The analytics includes at least one of the following: an analytics corresponding to each piece of information among the at least one piece of information; or a corresponding analytics once all information among the at least one piece of information is combined.

In the embodiment of the present application, when intending to obtain the analytics, the first communication device may send the first request including at least one piece of information, the at least one piece of information includes at least one RSC and/or at least one PDU session parameter, and an analytics corresponding to each RSC/PDU session parameter, and/or the corresponding analytics once the plurality of RSCs/PDU session parameters are combined may be obtained based on the at least one piece of information. In this way, the corresponding analytics may be obtained through one or a combination of more of RSCs/PDU session parameters, so the certain limitations may be canceled, so that obtaining of the analytics is more flexible and the demand for obtaining the analytics is met.

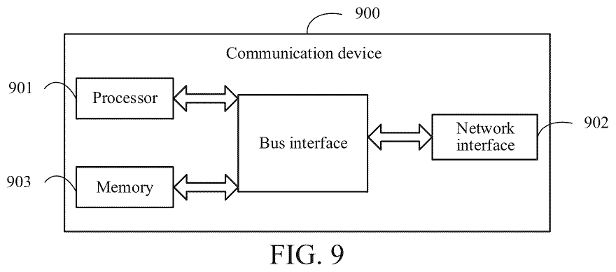

In some implementations, an embodiment of the present application further provides a communication device. As shown in FIG. 9, the network-side device 900 includes: a processor 901, a network interface 902, and a memory 903. The network interface 902 is, for example, a Common Public Radio Interface (CPRI).

In some implementations, the communication device 900 in the embodiment of the present application further includes: an instruction or program stored in the memory 903 and runnable on the processor 901. The processor 901 invokes the instruction or program in the memory 903 to perform the method performed by all the modules shown in FIG. 5 or FIG. 6, with the same technical effects achieved, and details are omitted here to avoid repetitions.

An embodiment of the present application further provides a readable storage medium. The readable storage medium stores a program or an instruction. The program or instruction, when executed by a processor, implements the procedures in the above embodiment of the method for obtaining the analytics, with the same technical effects achieved. To avoid repetitions, details are not described here again.

The processor may be a processor of the terminal in the foregoing embodiments. The readable storage medium includes a computer-readable storage medium, such as a computer read-only memory ROM, a random access memory RAM, a magnetic disc, an optical disc, or the like.

An embodiment of the present application further provides a chip. The chip includes a processor and a communication interface. The communication interface is coupled to the processor. The processor is configured to run a program or an instruction to implement the various procedures of the above embodiment of the method for obtaining the analytics and can achieve the same technical effects, and details are omitted here to avoid repetitions.

It should be understood that the chip mentioned in the embodiment of the present application may also be referred to as a system on a chip, a system chip, a chip system, a system-on-chip, or the like.

An embodiment of the present application further provides a computer program/program product. The computer program/program product is stored in a storage medium. The computer program/program product, when executed by at least one processor, implements the various procedures of the above embodiment of the method for obtaining the analytics and can achieve the same technical effects, and details are omitted here to avoid repetitions.

An embodiment of the present application further provides a system for obtaining an analytics, including: a first communication device and a second communication device, the first communication device may be configured to perform steps of the method for obtaining the analytics as shown in FIG. 2, and the second communication device may be configured to perform steps of the method for obtaining the analytics as shown in FIG. 4.

It needs to be noted that terms “include,” “comprise,” or any other variants thereof herein are intended to cover a non-exclusive inclusion, so that a process, a method, an object, or an apparatus including a series of elements not only includes those elements but also includes other elements which are not clearly listed or further includes intrinsic elements of the process, the method, the object, or the apparatus. Without more limitations, an element defined by a sentence “including one” does not exclude a case that there are still other same elements in the process, method, object, or apparatus that includes the element. In addition, it should be pointed out that the range of the method and apparatus in the implementation of the present application is not limited to execution of functions in order shown or discussed, and can further include execution of functions involved in a substantially simultaneous manner or in a reverse order. For example, the described method can be executed in order different from that described, and various steps may be added, omitted, or combined. Moreover, features described with reference to some examples may be combined in other examples.

According to the descriptions in the foregoing implementations, those skilled in the art may clearly learn that the method according to the foregoing embodiment may be implemented by relying on software and a necessary general-purpose hardware platform or certainly by using hardware, but in most of cases, the former is the better implementation. Based on such an understanding, the technical solutions of the present application essentially, or a part contributing to the related art, may be presented in a form of a computer software product. The computer software product is stored in a storage medium (for example, an ROM/RAM, a magnetic disk, or an optical disc), and includes several instructions to enable a terminal (which may be a mobile phone, a computer, a server, an air conditioner, a network device, or the like) to perform the methods described in the embodiments of the present application.

The embodiments of the present application are described above with reference to the accompanying drawings, but the present application is not limited to above specific implementations. The above specific implementations are merely illustrative rather than restrictive. Inspired by the present application, those of ordinary skill in the art may still make multiple forms without departing from the essence of the present application and the scope of protection of the claims, which all fall within the protection of the present application.

What is claimed is:

1. A method for obtaining an analytics, performed by a first communication device, comprising:
sending a first request, wherein the first request comprises at least one piece of information, the at least one piece of information comprises at least one Route Selection Component (RSC) or at least one Protocol Data Unit (PDU) session parameter, and the first request is used for requesting to obtain the analytics; and
receiving a first response, wherein the first response comprises the analytics;
wherein the analytics comprises at least one of the following:
an analytics corresponding to each piece of information among the at least one piece of information; or
an analytics corresponding to a combination of all pieces of information among the at least one piece of information.

2. The method according to claim 1, wherein the analytics corresponding to each piece of information among the at least one piece of information comprises at least one of the following:
an analytics corresponding to each RSC in the at least one RSC; or
an analytics corresponding to each PDU session parameter in the at least one PDU session parameter; and wherein
the analytics corresponding to the combination of all pieces of information among the at least one piece of information comprises at least one of the following:
the analytics corresponding to the combination of all RSCs among the at least one RSC; or
the analytics corresponding to the combination of all PDU session parameters among the at least one PDU session parameter.

3. The method according to claim 1, further comprising:
performing a User Equipment (UE) Route Selection Policy (URSP) rule adjustment operation according to the analytics, wherein the URSP rule adjustment operation comprises at least one of the following:
modifying a Route Selection Descriptor (RSD) priority;
modifying an RSC in the RSD; or
generating a new URSP rule.

4. The method according to claim 1, wherein sending the first request comprises:
sending the first request to a second communication device;
wherein receiving the first response comprises:
receiving the first response from the second communication device, wherein the analytics is determined by the second communication device according to the first request.

5. The method according to claim 1, wherein the at least one RSC or the at least one PDU session parameter comprises at least one of the following:
a PDU session type;
a Session and Service Continuity (SSC) mode;
an access type;
Single Network Slice Selection Assistance Information (S-NSSAI); or
a Data Network Name (DNN); and
the at least one PDU session parameter comprises at least one of the following:
the PDU session type;
the SSC mode;
the access type;
the S-NSSAI; or
the DNN.

6. The method according to claim 5, wherein the PDU session type comprises at least one of the following:
an Ethernet type;
unstructured;
an Internet protocol fourth version (IPV4) type;
an Internet protocol sixth version (IPV6) type; or
an IPV4V6 type.

7. The method according to claim 5, wherein the SSC mode comprises at least one of the following:
SSC mode 1;
SSC mode 2; or
SSC mode 3.

8. The method according to claim 5, wherein the access type comprises at least one of the following:
Wireless Local Area Networks (WLAN);
a Public Land Mobile Network (PLMN) ID;
5G;
4G
a Next Generation Radio Access Network (NG-RAN);
an Evolved Universal mobile telecommunications system Terrestrial Radio Access Network (E-UTRAN);
trusted WLAN; or
multi-access.

9. The method according to claim 1, wherein the first request comprises second information, and the second information is used for indicating at least one of the following:
obtaining the analytics corresponding to each piece of information among the at least one piece of information; or
obtaining the analytics corresponding to a combination of all pieces of information among the at least one piece of information.

10. The method according to claim 1, wherein the first request further comprises an application ID of a target application, and the analytics that the first request is used for requesting to obtain comprises at least one of the following:
an analytics corresponding to the application ID that is combined with each piece of information among the at least one piece of information; or
an analytics corresponding to the application ID that is combined with all pieces of information among the at least one piece of information.

11. The method according to claim 10, further comprising:
sending a second request, wherein the second request comprises a traffic descriptor parameter, and the second request is used for requesting to obtain the application ID of the target application corresponding to the traffic descriptor parameter; and
receiving a second response, wherein the second response comprises the application ID of the target application.

12. The method according to claim 11, wherein the traffic descriptor parameter comprises at least one of the following:
connection capabilities;
application descriptors;
IP descriptors;
non-IP descriptors;
a Fully Qualified Domain Name (FQDN); or
a Data Network Name (DNN).

13. The method according to claim 11, wherein sending the second request comprises:
sending the second request to a third communication device;
wherein receiving the second response comprises:
receiving the second response from the third communication device, wherein the application ID of the target application is determined by the third communication device according to the traffic descriptor parameter and a preset mapping relationship, and the preset mapping relationship is a mapping relationship between the traffic descriptor parameter and the application ID, wherein
the mapping relationship is obtained by the third communication device from a fourth communication device, and the mapping relationship is provided by a fifth communication device and stored by the fifth communication device into the fourth communication device through the third communication device; or
the mapping relationship is provided by the third communication device.

14. The method according to claim 1, wherein the first request further comprises a traffic descriptor parameter, and the analytics that the first request is used for requesting to obtain comprises at least one of the following:
an analytics corresponding to the traffic descriptor parameter that is combined with each piece of information among the at least one piece of information; or
an analytics corresponding to the traffic descriptor parameter that is combined with all pieces of information among the at least one piece of information, and
wherein the first request comprises fourth information, and the fourth information is used for indicating at least one of the following:
obtaining the analytics corresponding to the traffic descriptor parameter that is combined with each piece of information among the at least one piece of information; or
obtaining the analytics corresponding to the traffic descriptor parameter that is combined with all pieces of information among the at least one piece of information.

15. The method according to claim 1, wherein the first communication device comprises at least one of the following: a Policy Control Function (PCF), an Access and Mobility Management PCF (AM-PCF), a User Equipment PCF (UE-PCF), or at least one core network device.

16. The method according to claim 4, wherein the second communication device comprises: Network Data Analytics Function (NWDAF).

17. A method for obtaining an analytics, performed by a second communication device, comprising:
receiving a first request, wherein the first request comprises at least one piece of information, the at least one piece of information comprises at least one Route Selection Component (RSC) or at least one Protocol Data Unit (PDU) session parameter, and the first request is used for requesting to obtain an analytics;
determining the analytics according to the first request; and
sending a first response, wherein the first response comprises the analytics,
wherein the analytics comprises at least one of the following:
an analytics corresponding to each piece of information among the at least one piece of information; or
an analytics corresponding to a combination of all pieces of information among the at least one piece of information.

18. The method according to claim 17, wherein receiving the first request comprises:
receiving the first request from a first communication device,
wherein sending the first response comprises:
sending the first response to the first communication device.

19. The method according to claim 17, wherein the at least one RSC or the at least one PDU session parameter comprises at least one of the following:
a PDU session type;
an SSC mode;
an access type;
S-NSSAI; or
DNN; and
the at least one PDU session parameter comprises at least one of the following:
the PDU session type;
the SSC mode;
the access type;
the S-NSSAI; or
the DNN.

20. A first communication device, comprising:
a memory storing computer-readable instructions; and
a processor coupled to the memory and configured to execute the computer-readable instructions, wherein the computer-readable instructions, when executed by the processor, cause the processor to perform operations comprising:
sending a first request, wherein the first request comprises at least one piece of information, the at least one piece of information comprises at least one Route Selection Component (RSC) or at least one Protocol Data Unit (PDU) session parameter, and the first request is used for requesting to obtain the analytics; and
receiving a first response, wherein the first response comprises the analytics;
wherein the analytics comprises at least one of the following:
an analytics corresponding to each piece of information among the at least one piece of information; or
an analytics corresponding to a combination of all pieces of information among the at least one piece of information.
